(19) United States
(12) Patent Application Publication
(10) Pub. No.: US 2013/0073456 A1
(43) Pub. Date: Mar. 21, 2013

(54) SERVICE PROVISION SYSTEM INCLUDING PLURALITY OF SUBSYSTEMS FOR PROVIDING THE SAME SERVICE, AND SERVICE PROVISION METHOD

(71) Applicants: Hideyuki Matsuda, Hirakata-shi (JP); Manabu Furukawa, Nagaokakyo-shi (JP); Nobuhiro Mishima, Osaka-shi (JP); Kazusei Takahashi, Nishinomiya-shi (JP); Mitsuharu Nagai, Amagasaki-shi (JP)

(72) Inventors: Hideyuki Matsuda, Hirakata-shi (JP); Manabu Furukawa, Nagaokakyo-shi (JP); Nobuhiro Mishima, Osaka-shi (JP); Kazusei Takahashi, Nishinomiya-shi (JP); Mitsuharu Nagai, Amagasaki-shi (JP)

(73) Assignee: Konica Minolta Business Technologies, Inc., Chiyoda-ku (JP)

(21) Appl. No.: 13/611,053

(22) Filed: Sep. 12, 2012

(30) Foreign Application Priority Data
Sep. 20, 2011 (JP) 2011-204262

(51) Int. Cl. G06Q 30/04

(52) U.S. Cl. 705/40

(57) ABSTRACT

A subsystem of a first kind includes a first fee table receiving portion for receiving a first fee table, a user-restricted provision portion for providing a service, and an uncollected history record transmitting portion to transmit to a summation server an uncollected history record including a history record of providing a service. A subsystem of a second kind includes a post-collection provision portion for providing a service if a fee defined by a second fee table is collected, a collected history record transmitting portion to transmit to the summation server a collected history record including a history record of providing a service, a proxy provision portion for providing a service before a fee for the service is collected, and a switch control portion for comparing the first fee table with the second fee table and allowing the post-collection provision portion or the proxy provision portion to provide a service.

This application is based on Japanese Patent Application No. 2011-204262 filed with Japan Patent Office on Sep. 20, 2011, the entire content of which is hereby incorporated by reference.

### BACKGROUND OF THE INVENTION

1. Field of the Invention

The present invention relates to a service provision system. More specifically, the present invention relates to a service provision system including a plurality of subsystems for providing the same service, and to a service provision method.

2. Description of the Related Art

In some conventional image forming apparatuses such as copiers, users are charged for execution of processes on the condition that the users using the image forming apparatus are the authenticated users. For example, Japanese Patent Laid-Open No. 2005-107711 discloses a peripheral device management system having a peripheral device for receiving and processing a job, a client for transmitting a job to the peripheral device, an IC card for use in user authentication of the client, and a network for connecting them. The IC card has means for holding and updating a charge account of the user of the IC card, and means for issuing a job ticket that is a job issue permission for the client. The job at least includes the issued job ticket as attribute information. The peripheral device has means for interpreting the job ticket included in the attribute information of the job, and means for validating that the job issued is permitted by the IC card through interpretation of the job ticket.

However, the peripheral device management system can be adopted only in a single closed system including a client and a peripheral device. For example, in two systems in which different fees are defined for the same process, the respective fees of the two systems should be adopted for execution of a process. Even when the fee defined in one system is cheaper than the fee defined in the other system, the higher fee is charged for execution of a process in the other system.

### SUMMARY OF THE INVENTION

In order to achieve the object described above, according to an aspect of the present invention, a service provision system includes a summation server and a plurality of subsystems. The summation server includes: a subsystem-basis fee table storing portion to store, for each of the plurality of subsystems, a fee table that defines a fee for a service provided by the subsystem; a history record acquisition portion to acquire a history record of providing a service from each of the plurality of subsystems; and a summation portion to sum a billing amount using a fee table for each of the plurality of subsystems, based on the acquired history record. The plurality of subsystems including a first kind and a second kind. The subsystem of the first kind includes: a first fee table receiving portion to receive a first fee table for the subsystem from the summation server; a first authentication portion to authenticate a user registered in advance in the subsystem of the first kind; a user-restricted provision portion to provide a service on condition that a user is authenticated as the registered user; an uncollected history record transmitting portion to transmit to the summation server an uncollected history record including a history record of the user-restricted provision portion providing a service; and a subsystem information transmitting portion to, in response to a request from a portable information device carried by the registered user, transmit to the portable information device first subsystem information including the first fee table and subsystem identification information for identifying the subsystem of the first kind. The subsystem of the second kind includes: a second fee table receiving portion to receive a second fee table for the subsystem from the summation server; a post-collection provision portion to provide a service on condition that a fee defined by the received second fee table is collected; a collected history record transmitting portion to transmit to the summation server a collected history record including a history record of the post-collection provision portion providing a service; a subsystem information receiving portion to receive the first subsystem information including the first fee table and the subsystem identification information from the portable information device carried by the user; a proxy provision portion to provide a service before a fee for the service is collected, if the first subsystem information is received by the subsystem information receiving portion; a proxy history record transmitting portion to transmit to the summation server a proxy history record including a history record of the proxy provision portion providing a service and the subsystem identification information included in the first subsystem information; an operation accepting portion to accept a user's operation; a service specifying portion to obtain service specifying information accepted by the operation accepting portion for specifying a service; and a switch control portion to compare the first fee table with the second fee table for providing the service specified by the obtained service specifying information, and to allow one of the post-collection provision portion and the proxy provision portion to provide a service.

According to another aspect of the present invention, a service provision method is executed in a service provision system including a summation server and a plurality of subsystems. The summation server includes a subsystem-basis fee table storing portion to store, for each of the plurality of subsystems, a fee table that defines a fee for a service provided by the subsystem. The method allows the summation server to execute: a step of acquiring a history record of providing a service from each of the plurality of subsystems; and a step of summing a billing amount using the fee table for each of the plurality of subsystems, based on the acquired history record. The plurality of subsystems including a first kind and a second kind. The method allows the subsystem of the first kind to execute: a step of receiving a first fee table for the subsystem from the summation server; a step of authenticating a user registered in advance in the subsystem of the first kind; a user-restricted provision step of providing a service on condition that a user is authenticated as the registered user; a step of transmitting to the summation server an uncollected history record including a history record of providing a service in the user-restricted provision step; and a step of, in response to a request from a portable information device carried by the registered user, transmitting to the portable information device first subsystem information including the first fee table and subsystem identification information for identifying the subsystem of the first kind. The method allows the subsystem of the second kind to execute: a step of receiving a second fee table for the subsystem from the summation server; a post-collection provision step of providing a service on condition that a fee defined by the received second fee table is collected; a step of transmitting to the summation server a collected history record including a history record of providing a service in the post-collection provision step; a step of receiving the first subsystem information including the first fee table and the subsystem identification information from the portable information device carried by the user; a proxy provision step of providing a service before a fee for the service is collected, if the first subsystem information is received; a proxy history record transmitting step of transmitting to the summation server a proxy history record including a history record of providing a service in the proxy provision step and the subsystem identification information included in the first subsystem information; a step of accepting a user's operation; a step of obtaining service specifying information accepted in the step of accepting a user's operation for specifying a service; and a switch control step of comparing the first fee table with the second fee table for providing the service specified by the obtained service specifying information, and executing one of the post-collection provision step and the proxy provision step.

The foregoing and other features, aspects, and advantages of the present invention will become more apparent from the following detailed description of the present invention when taken in conjunction with the accompanying drawings.

### BRIEF DESCRIPTION OF THE DRAWINGS

FIG. 1 is a diagram showing a general overview of a service provision system in an embodiment of the present invention.

FIG. 2 is a diagram showing an exemplary hardware configuration of a summation server.

FIG. 3 is a diagram showing an exemplary hardware configuration of a local server.

FIG. 4 is a block diagram showing an exemplary hardware configuration of an MFP.

FIG. 5 is a functional block diagram showing an overview of a hardware configuration of a portable information device.

FIG. 6 is a block diagram showing an example of functions of the CPU of the summation server, with data stored in the HDD.

FIG. 7 is a block diagram showing an example of functions of the CPU of the local server in the first subsystem.

FIG. 8 is a diagram showing an example of a first fee table.

FIG. 9 is a block diagram showing an example of functions of the CPU of the MFP included in the first subsystem.

FIG. 10 is a block diagram showing an example of functions of the CPU of the MFP included in the second subsystem.

FIG. 11 is a diagram showing an example of a second fee table.

FIG. 12 is a diagram showing details of an example of functions of a switch control portion.

FIG. 13 is a flowchart showing an exemplary flow of a fee table management process.

FIG. 14 is a flowchart showing an exemplary flow of a summation process.

FIG. 15 is a flowchart showing an exemplary flow of a subsystem registration process.

FIG. 16 is a flowchart showing an exemplary flow of a history record management process.

FIG. 17 is a flowchart showing an exemplary flow of a first service provision process.

FIG. 18 is a flowchart showing an exemplary flow of a second service provision process.

FIG. 19 is a flowchart showing an exemplary flow of a switch control process.

FIG. 20 is a diagram showing details of exemplary functions of a switch control portion according to a first modification.

FIG. 21 is a flowchart showing an exemplary flow of a switch control process in the first modification.

FIG. 22 is a diagram showing details of exemplary functions of a switch control portion according to a second modification.

FIG. 23 is a diagram showing an example of a comparison information screen.

FIG. 24 is a flowchart showing an exemplary flow of a switch control process in the second modification.

FIG. 25 is a diagram showing details of exemplary functions of a switch control portion according to a third modification.

FIG. 26 is a diagram showing an example of a third fee table.

FIG. 27 is a diagram showing an example of a total billing amount screen.

FIG. 28 is a diagram showing an example of an internal table.

FIG. 29 is a first flowchart showing an exemplary flow of a switch control process in the third modification.

FIG. 30 is a second flowchart showing an exemplary flow of the switch control process in the third modification.

### DESCRIPTION OF THE PREFERRED EMBODIMENTS

Embodiments of the present invention will be described below with reference to the drawings. In the following description, the same parts are denoted with the same reference numerals. Their names and functions are also the same. Therefore, a detailed description thereof will not be repeated.

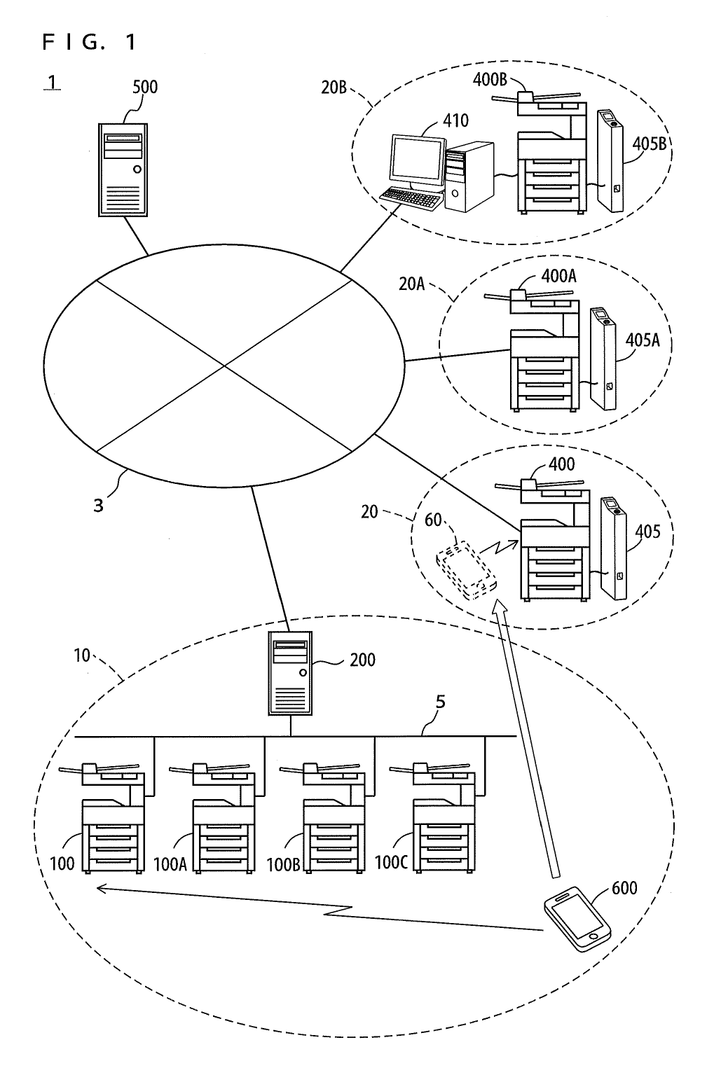

FIG. 1 is a diagram showing a general overview of a service provision system in an embodiment of the present invention. Referring to FIG. 1, a service provision system 1 includes a summation server 500, a first subsystem 10 of a first kind, second subsystems 20, 20A, and 20B of a second kind, and a portable information device 600 carried by a user. Summation server 500, first subsystem 10, and second subsystems 20, 20A, and 20B are each connected to the Internet 3 so that they can communicate with each other. Here, the Internet 3 is used by way of example, although a local area network or a wide area network may be used.

Service provision system 1 provides a service in each of first subsystem 10 and second subsystems 20, 20A, and 20B, charges for the provided service, and sums the charges in summation server 500 for each of first subsystem 10 and second subsystems 20, 20A, and 20B. Specifically, each of first subsystem 10 and second subsystems 20, 20A, and 20B provides a service to a user and transmits history record information for charging for the provided service to summation server 500 through the Internet 3. Although first subsystem 10 and second subsystems 20, 20A, and 20B can provide the same service, the price for the service may differ between first subsystem 10 and second subsystems 20, 20A, and 20B.

In the example shown, service provision system 1 includes one first subsystem 10 and three second subsystems 20, 20A, and 20B. However, the number of first subsystem 10 and second subsystems 20, 20A, and 20B is not limited. A plurality of first subsystems 10 may be present, and one or more second subsystems 20, 20A, 20B may be present.

Here, a business operator A administers service provision system 1, and business operators B to E receive provision of service, by way of example. In the example described here, business operator A owns summation server 500, first subsystem 10 is installed at a place available to business operator B, and second subsystems 20, 20A, and 20B are installed at places available to business operators C to E, respectively. In this case, the price of a service in first subsystem 10 is decided on between business operator A and business operator B, and a fee table that defines a rate for each service is stored in summation server 500 and used in summation server 500 and first subsystem 10.

The price for a service in second subsystem 20 is decided on between business operator A and business operator C, and a fee table that defines a rate for each service is stored in summation server 500 and used in summation server 500 and second subsystem 20. Similarly, the price for a service in second subsystem 20A is decided on between business operator A and business operator D, and a second fee table that defines a rate for each service is stored in summation server 500 and used in summation server 500 and second subsystem 20A. The price for a service in second subsystem 20B is decided on between business operator A and business operator E, and a second fee table that defines a rate for each service is stored in summation server 500 and used in summation server 500 and second subsystem 20B.

Here, the fee table that defines the price for a service in first subsystem 10 is referred to as a first fee table. The prices for a service in second subsystem 20, 20A, and 20B are the same, and the fee table that defines the price for a service is referred to as a second fee table.

Summation server 500 is a general personal computer and installed with a program for acquiring history records at least from first subsystem 10 and second subsystems 20, 20A, and 20B.

First subsystem 10 includes a local server 200 and four multi-functional peripherals (hereinafter referred to as “MFPs”) 100, 100A, 100B, and 100C. Local server 200 and four MFPs 100, 100A, 100B, and 100C are connected to a LAN (Local Area Network) 5 so that they can communicate with each other. In the example shown, first subsystem 10 includes four MFPs 100, 100A, 100B, and 100C. However, the number of MFPs is not limited as long as at least one MFP is present. MFPs 100, 100A, 100B, 100C have the same hardware configuration and functions. In the following description, MFP 100 will be described as an example, unless otherwise specified.

Second subsystems 20 and 20A include MFPs 400 and 400A, respectively. Second subsystem 20B includes an MFP 400B and a communication device 410. MFPs 400, 400A, and 400B are connected to coin vendors 405, 405A, and 405B, respectively, to execute a process on the condition that fees are paid through coin vendors 405, 405A, 405B.

Communication device 410 included in second subsystem 20B is provided between summation server 500 and MFP 400B and has a communication function. MFPs 400, 400A, and 400B have the same hardware configuration. MFPs 400, 400A, and 400B are different in that MFPs 400 and 400A have a function of communication device 410 included in second subsystem 20B, whereas MFP 400B does not have that function. Other functions are the same. MFPs 400, 400A, and 400B are different from MFPs 100 and 100A to 100C in that they have a function of collecting the price for a service. The function of collecting the price for a service may include collection using credit cards instead of coin vendors 405, 405A, and 405B.

In the present embodiment, summation server 500 is under management of business operator A, by way of example. A registered user such as an employee for business operator B is allowed to use first subsystem 10, by way of example. Second subsystems 20, 20A, and 20B are installed, for example, at convenience stores, etc. operated by business operators C to E, respectively, and any user is allowed to use second subsystems 20, 20A, and 20B, by way of example.

Portable information device 600 is a general PDA (Personal Digital Assistant) carried by a user. Portable information device 600 has a short-range radio communication unit for wirelessly communicating with MFP 100 having a short-range radio communication unit at the other end present in a prescribed range of distance. Portable information device 600 is installed with an application program for executing various processes. Here, portable information device 600 is installed with an application program for receiving the first fee table from any one of MFPs 100 and 100A to 100C and transmitting the first fee table to any one of MFPs 400, 400A, and 400B, by way of example.

Service provision system 1 in the present embodiment allows a user capable of using first subsystem 10 to receive provision of a service for a fee defined by the first fee table in first subsystem 10, by downloading the first fee table to portable information device 600 carried by the user from any one of MFPs 100 and 100A to 100C and uploading the first fee table from portable information device 600 to one of MFPs 400, 400A, and 400B to be used.

In the present embodiment, provision of a service is implemented by MFPs 100, 100A to 100C, 400, 400A, and 400B executing a process. Since MFPs 100, 100A to 100C, 400, 400A, and 400B can execute a plurality of processes, one service may be provided by executing one or more processes. Here, a combination of one or more processes executed by each MFP 100, 100A to 100C, 400, 400A, 400B is called a job, and execution of one job is called a service. Examples of a process executable by each of MFPs 100, 100A to 100C, 400, 400A, and 400B include a scan process of scanning an original and converting the scanned original into electronic data, an image forming process of forming an image of data on paper, a character recognition process of recognizing characters from image data, an image processing function of executing a variety of image processing such as a sharpening process on image data, a sorting process of sorting sheets having images formed thereon, a punching process, a stapling process, a data storage process of storing data, and a data transmission process of transmitting data by email.

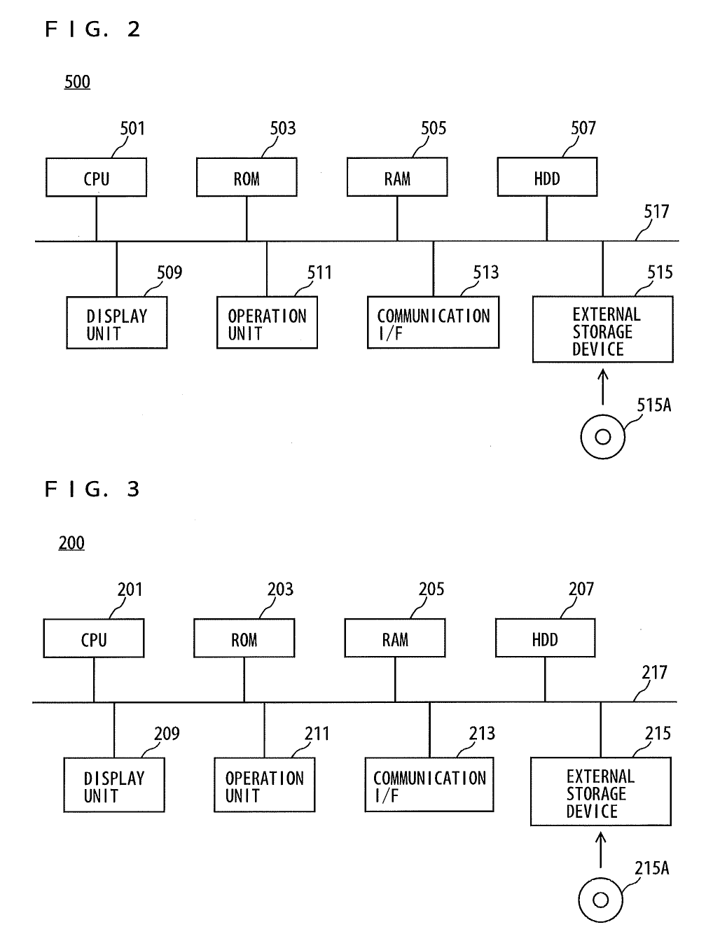

FIG. 2 is a diagram showing an exemplary hardware configuration of the summation server. Referring to FIG. 2, summation server 500 includes a CPU 501 for controlling the entire summation server 500, a ROM 503 for storing a program executed by CPU 501, a RAM 505 for use as a work area of CPU 501, an HDD 507 serving as a mass storage device, a display unit 509, an operation unit 511 for accepting an operation input by the user, a communication I/F 513 for connecting summation server 500 to the Internet 3, and an external storage device 515, each being connected to a bus.

A CD-ROM (Compact Disc-ROM) 515A encoded with a program is attached to external storage device 515. CPU 501 loads the program stored in CD-ROM 515A to RAM 505 through external storage device 515 and executes the program. A recording medium for storing a program is not limited to CD-ROM 515A and may be a flexible disk, a cassette tape, an optical disk (MO (Magnetic Optical Disc)/MD (Mini Disc)/DVD (Digital Versatile Disc)), an IC card, an optical card, or a semiconductor memory such as a mask ROM, an EPROM (Erasable Programmable ROM), or an EEPROM (Electrically Erasable and Programmable ROM). A program stored in HDD 507 may be loaded to RAM 505 for execution. In this case, summation server 500 may download a program from another computer connected to the Internet 3 and store the downloaded program into HDD 507. The program referred to here includes not only a program directly executable by CPU 501 but also a source program, a compressed program, an encrypted program, and the like.

FIG. 3 is a diagram showing an exemplary hardware configuration of the local server. Referring to FIG. 3, local server 200 includes a CPU 201 for controlling the entire local server 200, a ROM 203 for storing a program executed by CPU 201, a RAM 205 for use as a work area of CPU 201, an HDD 207 serving as a mass storage device, a display unit 209, an operation unit 211 for accepting an operation input by the user, a communication I/F 213 for connecting local server 200 to LAN 5 and the Internet 3, and an external storage device 215, each being connected to a bus 217.

Communication I/F 213 is an interface for connecting CPU 201 to LAN 5 and the Internet 3. CPU 201 communicates with MFPs 100 and 100A to 100C and with summation server 500 through communication I/F 213 to transmit/receive data.

A CD-ROM 215A encoded with a program is attached to external storage device 215. CPU 201 loads the program stored in CD-ROM 215A to RAM 205 through external storage device 215 and executes the program. A recording medium for storing a program is not limited to CD-ROM 215A and may be a flexible disk, a cassette tape, an optical disk (MO/MD/DVD), an IC card, an optical card, or a semiconductor memory such as a mask ROM, an EPROM, or an EEPROM. A program stored in HDD 207 may be loaded to RAM 205 for execution. In this case, local server 200 may download a program from another computer connected to the Internet 3 and store the downloaded program into HDD 207. The program referred to here includes not only a program directly executable by CPU 201 but also a source program, a compressed program, an encrypted program, and the like.

In the present embodiment, the hardware configurations of MFPs 100, 100A to 100C and MFPs 400, 400A, 400B are the same. Here, the hardware configuration of MFP 100 will be described as an example. MFPs 100, 100A to 100C and MFPs 400, 400A, 400B may have different hardware configurations but at least have a function of forming an image for providing the same service.

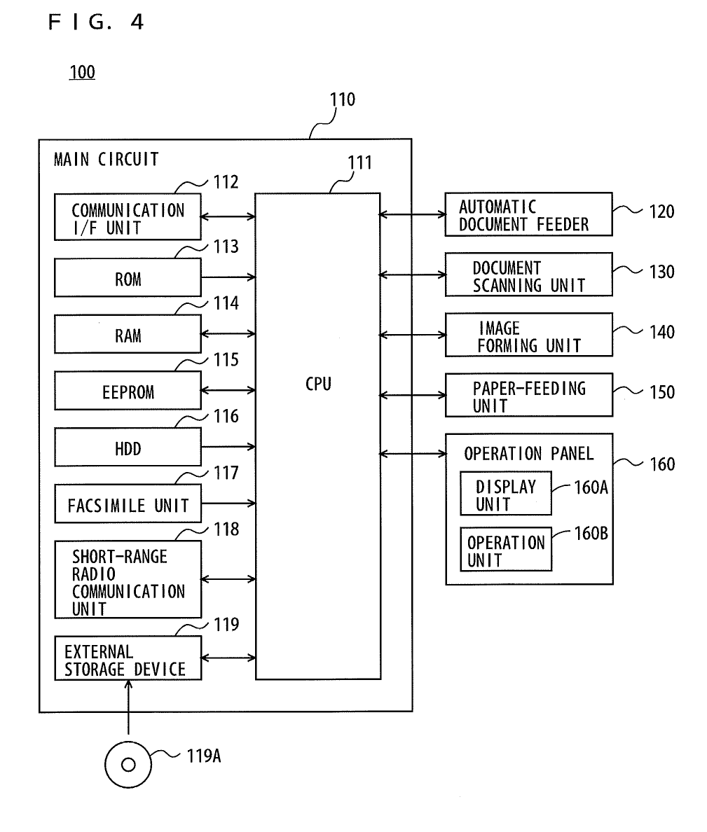

FIG. 4 is a block diagram showing an exemplary hardware configuration of the MFP. Referring to FIG. 4, MFP 100 includes a main circuit 110, a document scanning unit 130 for scanning a document, an automatic document feeder 120 for conveying a document to document scanning unit 130, an image forming unit 140 for forming an image on paper or the like based on image data output by document scanning unit 130 scanning a document, a paper-feeding unit 150 for supplying paper to image forming unit 140, and an operation panel 160 serving as a user interface.

Main circuit 110 includes a CPU 111, a communication interface (I/F) unit 112, a ROM 113, a RAM 114, an EEPROM (Electronically Erasable and Programmable ROM) 115, a HDD (hard disk drive) 116 serving as mass storage device, a facsimile unit 117, a radio communication unit 118, and an external storage device 119 to which a CD-ROM 119A is attached. CPU 111 is connected to automatic document feeder 120, document scanning unit 130, image forming unit 140, paper feeding unit 150, and operation panel 160 to control the entire MFP 100.

ROM 113 stores a program executed by CPU 111 or data necessary to execute the program. RAM 114 is used as a working area for CPU 111 to execute a program. RAM 114 temporarily stores scanned data (image data) successively sent from document scanning unit 130.

Operation panel 160 is provided on a top surface of MFP 100 and includes a display unit 160A and an operation unit 160B. Display unit 160A is a display such as a liquid crystal display (LCD) or an organic ELD (Electroluminescence Display) and displays instruction menus to users, information about the acquired image data, and the like. Operation unit 160B has a plurality of keys and accepts a variety of instructions and input of data such as characters and numerals according to the user's operation corresponding to the keys. Operation unit 160B further includes a touch panel provided on display unit 160A.

Communication I/F unit 112 is an interface for connecting MFP 100 to LAN 5. CPU 111 communicates with local server 200 connected to LAN 5 through communication I/F unit 112 to transmit/receive data. When LAN 5 is connected to the Internet 3, communication I/F unit 112 can communicate with a computer connected to the Internet 3. Communication I/F unit 112 of each MFP 400, 400A is an interface for connecting CPU 111 of each MFP 400, 400A to the internet 3. CPU 111 of each MFP 400, 400A, 400B communicates with summation server 500 connected to the Internet 3 through communication I/F unit 112 to transmit/receive data. Communication I/F unit 112 of MFP 400B is an interface for connecting CPU 111 of MFP 400B to communication device 410. Communication device 410 has a function of connecting MFP 400B to the Internet 3 and communicates with summation server 500 to transmit/receive data.

Facsimile unit 117 is connected to a PSTN (Public Switched Telephone Network) to transmit facsimile data to the PSTN or receive facsimile data from the PSTN. Facsimile unit 117 stores the received facsimile data into HDD 116 or outputs the same to image forming unit 140. Image forming unit 140 prints the facsimile data received by facsimile unit 117 on paper. Facsimile unit 117 converts the data stored in HDD 116 into facsimile data for transmission to a facsimile machine connected to the PSTN.

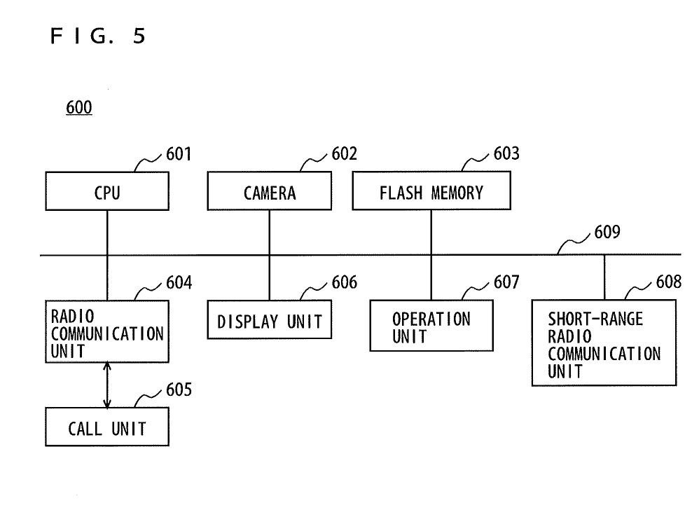

Short-range radio communication unit 118 wirelessly communicates with short-range radio communication unit 608 (see FIG. 5) of portable information device 600 when portable information device 600 is present in a communicable range. Short-range radio communication unit 118 may communicate with any communication medium and has a function of wireless communication, for example, according to a communication standard of IrDA (Infrared Data Association) or Bluetooth (R). The protocol for transmitting/receiving data is not specifically limited, and any protocol may be used. The distance in which short-range radio communication unit 118 can communicate is limited to a prescribed distance and is preferably a few meters to a few tens of meters, although not specifically limited thereto. Short-range radio communication unit 118 detects portable information device 600 and becomes ready for communication when portable information device 600 is present in a communicable range of distance.

CD-ROM 119A is attached to external storage device 119. CPU 111 can access CD-ROM 119A through external storage device 119. CPU 111 loads the program recorded on CD-ROM 119A attached to external storage device 119 into RAM 114 for execution. The program executed by CPU 111 is not limited to a program stored in CD-ROM 119A, and a program stored in HDD 116 may be loaded to RAM 114 for execution. In this case, another computer connected to a network may overwrite the program stored in HDD 116 of MFP 100 or additionally write a new program. Furthermore, MFP 100 may download a program from another computer connected to a network and store the program into HDD 116. The program referred to here includes not only a program directly executable by CPU 111 but also a source program, a compressed program, and an encrypted program.

A recording medium for storing a program executed by CPU 111 is not limited to CD-ROM 119A but may be a flexible disk, a cassette tape, an optical disk (MO/MD/DVD), an IC card, an optical card, or a semiconductor memory such as a mask ROM, an EPROM, or an EEPROM. A program stored in HDD 116 may be loaded to RAM 114 for execution. In this case, MFP 100 may download a program from another computer connected to the Internet 3 and store the downloaded program into HDD 116. The program referred to here includes not only a program directly executable by CPU 111 but also a source program, a compressed program, an encrypted program, and the like.

FIG. 5 is a functional block diagram showing an overview of a hardware configuration of the portable information device. Referring to FIG. 5, portable information device 600 includes a CPU 601 for controlling the entire portable information device 600, a camera 602, a flash memory 603 for storing data in a nonvolatile manner, a radio communication unit 604 connected to a call unit 605, a display unit 606 for displaying an image, an operation unit 607 for accepting a user's operation, and a short-range radio communication unit 608.

Radio communication unit 604 wirelessly communicates with a base station for mobile phones connected to a telephone communication network. Radio communication unit 604 connects portable information device 600 to a telephone communication network to allow communication using call unit 605. Radio communication unit 604 demodulates a radio signal received from the mobile phone base station to produce a voice signal, which is decoded to be output to call unit 605. Radio communication unit 604 encodes voice input from call unit 605 and transmits the encoded signal to the mobile phone base station. Call unit 605 includes a microphone and a speaker. Voice input from radio communication unit 604 is output from the speaker, and voice input from the microphone is output to radio communication unit 604. Radio communication unit 604 is controlled by CPU 601 to connect portable information device 600 to an email server to transmit/receive emails.

Camera 602 includes a lens and a photoelectric transducer element such as a CMOS (Complementary Metal Oxide Semiconductor) sensor. Light collected by the lens is focused on the CMOS sensor, which in turn transduces the received light into image data and outputs the image data to CPU 601. The CMOS sensor may be replaced by a CCD (Charge Coupled Device) sensor.

Display unit 606 is a display device such as an LCD (Liquid Crystal Display) or an organic ELD to display an instruction menu for the user and information about the acquired image data. Operation unit 607 includes a plurality of keys and a touch panel. Operation unit 607 accepts a variety of instructions through user's operation and input of data including characters and numerals. When the user points at a display surface of display unit 606, operation unit 607 outputs the position of the display surface that is detected by the touch panel, to CPU 601. CPU 601 detects the position the user points at on the screen appearing on the display 606, based on the position detected by the touch panel.

Short-range radio communication unit 608 wirelessly communicates with short-range radio communication unit 118 of MFP 100 according to a prescribed communication protocol when any one of MFPs 100, 100A to 100C, 400, 400A, and 400B, for example, MFP 100 is present in a communicable range of distance. Short-range radio communication unit 608 has a limited communication distance, which is preferably a few meters to a few tens of meters, although not specifically limited thereto. When any of MFPs 100, 100A to 100C, 400, 400A, and 400B is present in a communicable range of distance, short-range radio communication unit 608 detects a device that can communicate, among MFPs 100, 100A to 100C, 400, 400A, and 400B, and then becomes ready for communication.

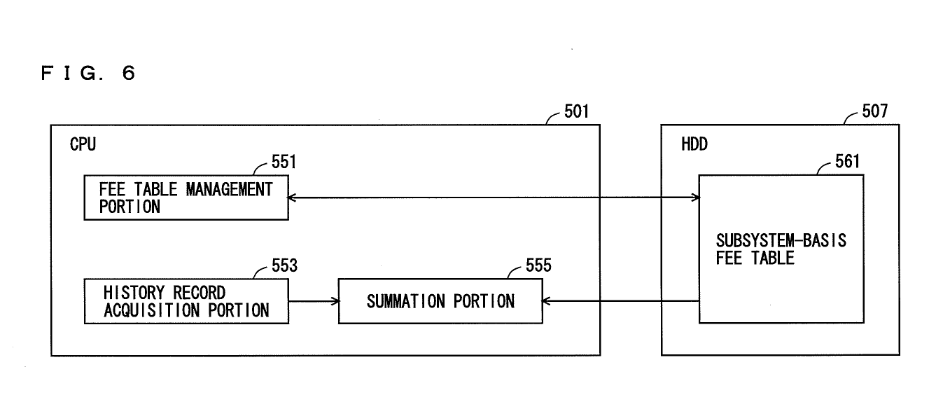

FIG. 6 is a block diagram showing an example of functions of the CPU of the summation server, with data stored in the HDD. The functions shown in FIG. 6 are implemented in CPU 501 by CPU 501 of summation server 500 executing a program stored in ROM 503, HDD 507, or CD-ROM 515A. Referring to FIG. 6, CPU 501 includes a fee table management portion 551 for managing a fee table, a history record acquisition portion 553 for acquiring history records of providing a service from each of the first and second subsystems 10, 20, 20A, and 20B, and a summation portion 555 for calculating the billing amount.

Fee table management portion 551 generates the first fee table for first subsystem 10 and the second fee table for each of second subsystems 20, 20A, and 20B and stores the generated first and second fee tables additionally into a subsystem-basis fee table 561 stored in HDD 507. The first fee table and the second fee table each associate process identification information for identifying a process with a rate charged for one execution of the service. For example, in an image forming process of forming a monochrome image on A4-size paper, with one execution of the process, a monochrome image is formed on one sheet of A4 paper, and for example, a rate of 50 yen is set for one execution of the process.

Fee table management portion 551 assigns subsystem identification information to first subsystem 10 when the administrator of summation server 500 inputs an instruction to register first subsystem 10 to operation unit 511. Then, when the administrator inputs the first fee table to operation unit 511, the first fee table is associated with the subsystem identification information and additionally stored in subsystem-basis fee table 561 stored in HDD 507. Similarly, when the administrator of summation server 500 inputs an instruction to register second subsystem 20 to operation unit 511, fee table management portion 551 assigns subsystem identification information to second subsystem 20. Then, when the administrator inputs the second fee table to operation unit 511, the second fee table is associated with the subsystem identification information and additionally stored in subsystem-basis fee table 561 stored in HDD 507. Registration of second subsystems 20A and 20B is similar to the registration of second subsystem 20. Therefore, subsystem-basis fee table 561 associates the first fee table with the subsystem identification information of first subsystem 10 and associates the second fee table with the respective subsystem identification information of second subsystems 20, 20A, and 20B.

In response to a registration request from each of first subsystem 10 and second subsystems 20, 20A, and 20B, fee table management portion 551 returns subsystem information including a set of the subsystem identification information and the fee table. If a transmission request is received from local server 200 of first subsystem 10, the first fee table associated with the subsystem identification information of first subsystem 10 is read out from HDD 507, and the subsystem information including the subsystem identification information of first subsystem 10 and the first fee table is returned to local server 200. If a transmission request is received from MFP 400 (400A) of second subsystem 20 (20A), the second fee table associated with the subsystem identification information of second subsystem 20 (20A) is read out from HDD 507, and the subsystem information including the subsystem identification information of second subsystem 20 (20A) and the second fee table is returned to MFP 400 (400A). If a transmission request is received from communication device 410 of second subsystem 20B, the second fee table associated with the subsystem identification information of second subsystem 20B is read out from HDD 507, and the subsystem information including the subsystem identification information of second subsystem 20B and the second fee table is returned to communication device 410.

History record acquisition portion 553 receives an uncollected history record from first subsystem 10 and outputs a set of the subsystem identification information of first subsystem 10 and the uncollected history record to summation portion 555. The uncollected history record includes an execution result. The execution result includes process identification information and the number of times of execution. Every time a service is provided, first subsystem 10 transmits an uncollected history record including an execution result for each of one or more processes executed to provide the service.

History record acquisition portion 553 receives a proxy history record and/or a collected history record from any one of second subsystems 20, 20A, and 20B and outputs, to summation portion 555, a set of the received proxy history record and/or collected history record and the subsystem identification information of the subsystem that has transmitted the proxy history record and/or collected history record, among second subsystems 20, 20A, and 20B. The proxy history record includes the subsystem identification information of first subsystem 10 and an execution result. The collected history record includes an execution result. Every time a service is executed, second subsystems 20, 20A, and 20B each transmits a proxy history record and/or collected history record including the execution result for each of one or more processes executed to provide the service.

Summation portion 555 sums the billing amount for each of first subsystem 10 and second subsystems 20, 20A, and 20B at prescribed time intervals, for example, at the end of every month.

<Billing Amount for First Subsystem>

In order to calculate the amount billed to first subsystem 10, summation portion 555 calculates the total number of times of execution for each process, using the uncollected history record to be paired with the subsystem identification information of first subsystem 10 and, among proxy history records, the proxy history record that includes the subsystem identification information of first subsystem 10. The total number of times of execution for each process for first subsystem 10 is calculated by integrating the number of times of execution of the same process identification information, using the execution result included in the uncollected history record that is paired with the subsystem identification information of first subsystem 10 and the execution result included in, among uncollected history records, the proxy history record including the subsystem identification information of first subsystem 10. Summation portion 555 calculates the billing amount by multiplying the number of times of execution for each of a plurality of processes by the rate associated therewith in the first fee table.

<Billing Amount for Second Subsystem>

A method of calculating the billing amount is the same among second subsystems 20, 20A, and 20B. Therefore, a method of calculating the billing amount for second subsystem 20 will be described here. In order to calculate the amount billed to second subsystem 20, summation portion 555 calculates the total number of times of execution for each process, using the collected history record paired with the subsystem identification information of second subsystem 20 and, among proxy history records, the proxy history record paired with the subsystem identification information of second subsystem 20. The total number of times of execution for each process for second subsystem 20 is calculated by integrating the number of times of execution of the same process identification information, using the execution result included in the collected history record paired with the subsystem identification information of second subsystem 20 and the execution result included in, among proxy history records, the proxy history record paired with the subsystem identification information of second subsystem 20. Summation portion 555 calculates a virtual billing amount by multiplying the number of times of execution for each of a plurality of processes by the rate associated therewith in the second fee table corresponding to second subsystem 20. Here, assuming that business operator A and business operator C make an agreement that a predetermined proportion of the virtual billing amount, for example, 30% should be paid from business operator C to business operator A, then 30% of the virtual billing amount is the amount billed to business operator C by business operator A. In second subsystem 20, the sales are earned by coin vendor 405 connected to MFP 400. Therefore, when the sales earned by coin vendor 405 exceed the billing amount, the amount that exceeds will be the profit for business operator B. Conversely, if the sales fall below, the balance is paid from business operator A to business operator C.

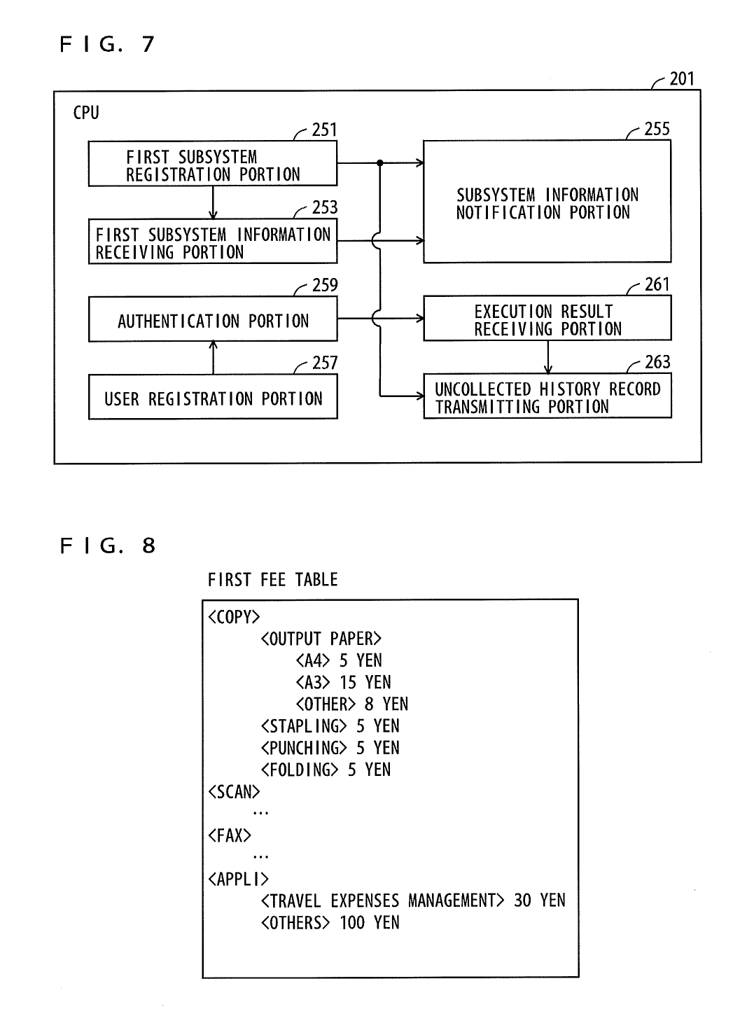

FIG. 7 is a block diagram showing an example of functions of the CPU of the local server in the first subsystem. The functions shown in FIG. 7 are implemented in CPU 201 by CPU 201 of local server 200 executing a program stored in ROM 203, HDD 207 or CD-ROM 215A. Referring to FIG. 7, CPU 201 includes a first subsystem registration portion 251, a first subsystem information receiving portion 253 for receiving the first fee table from summation server 500, a subsystem information notification portion 255, a user registration portion 257 for registering a user capable of using first subsystem 10, an authentication portion 259 for authenticating users who operate MFPs 100 and 100A to 100C, an execution result receiving portion 261 for receiving the execution results from MFPs 100 and 100A to 100C, and an uncollected history record transmitting portion 263 for transmitting an uncollected history record including an execution result to summation server 500.

First subsystem registration portion 251 registers first subsystem 10 in summation server 500 and also registers MFPs 100 and 100A to 100C in first subsystem 10.

<Registration in Summation Server>

For example, when the administrator of summation server 500 registers first subsystem 10 in summation server 500, summation server 500 assigns the subsystem identification information of first subsystem 10. The administrator of local server 200 receives a notification of the network address of summation server 500 and the subsystem identification information of first subsystem 10 from the administrator of summation server 500 and inputs them to operation unit 211. When the network address of summation server 500 and the subsystem identification information of first subsystem 10 are input by the administrator, first subsystem registration portion 251 transmits a subsystem registration request to summation server 500 and outputs a reception instruction to first subsystem information receiving portion 253. The reception instruction includes the network address of summation server 500. The registration request includes the subsystem identification information of first subsystem 10.

Upon receiving the registration request, summation server 500 returns the first subsystem information including a set of the subsystem identification information of first subsystem 10 and the first fee table. Therefore, when communication I/F 213 receives the first subsystem information from summation server 500 specified by the network address included in the reception instruction input from first subsystem registration portion 251, first subsystem information receiving portion 253 obtains the received first subsystem information, outputs the first subsystem information to subsystem information notification portion 255, and outputs the subsystem identification information included in the first subsystem information to uncollected history record transmitting portion 263.

<Registration of MFP>

First subsystem registration portion 251 accepts registration of MFPs 100 and 100A to 100C included in first subsystem 10. When receiving a device registration request from any one of MFPs 100 and 100A to 100C, first subsystem registration portion 251 registers the network address of the MFP that has transmitted the device registration request, among MFPs 100 and 100A to 100C, as a network address of an image processing apparatus included in first subsystem 10, and outputs the network address to subsystem information notification portion 255. In the following description, all MFPs 100 and 100A to 100C are registered in first subsystem 10, by way of example.

Subsystem information notification portion 255 receives the network address of any one of MFPs 100 and 100A to 100C from first subsystem registration portion 251 and receives the first subsystem information from first subsystem information receiving portion 253. In response to input of the network address from first subsystem registration portion 251, subsystem information notification portion 255 transmits the first subsystem information to the input network address through communication I/F 213. Thus, the first subsystem information is transmitted from the MFP that has transmitted the registration request, among MFPs 100 and 100A to 100C. The first subsystem information transmitted to MFPs 100 and 100A to 100C includes the subsystem identification information of first subsystem 10 and the first fee table.

<Registration of User>

User registration portion 257 registers a user capable of using first subsystem 10. For example, the administrator of local server 200 inputs the user identification information for identifying a user capable of using first subsystem 10 and a password to operation unit 211, so that a user record including the user identification information and the password is additionally stored in a user table stored in HDD 207 in advance. User registration portion 257 outputs the user table stored in HDD 207 to authentication portion 259.

When communication I/F 213 receives authentication information from any one of MFPs 100 and 100A to 100C, authentication portion 259 performs authentication using the user table based on the received authentication information. The authentication information includes user identification information and a password. If the user table includes a user record that includes the same identification information and password as the user identification information and password included in the authentication information, authentication portion 259 authenticates the user. If such a user record is not included, authentication portion 259 does not authenticate the user. If the user is authenticated, authentication portion 259 transmits the authentication result indicating a permission to the MFP that has transmitted the authentication information, among MFPs 100 and 100A to 100C, through communication I/F 213, and outputs the user identification information of the authenticated user to execution result receiving portion 261. If the user is not authenticated, authentication portion 259 transmits the authentication result indicating a non-permission, to the MFP that has transmitted the authentication information, among MFPs 100 and 100A to 100C, through communication I/F 213.

When communication I/F 213 receives an execution result from any one of MFPs 100 and 100A to 100C, execution result receiving portion 261 outputs the received execution result to uncollected history record transmitting portion 263.

Uncollected history record transmitting portion 263 receives subsystem identification information input from first subsystem registration portion 251 and an execution result input from execution result receiving portion 261. Uncollected history record transmitting portion 263 generates an uncollected history record including the subsystem identification information and the execution result and transmits the generated uncollected history record to summation server 500 through communication I/F 213. Uncollected history record transmitting portion 263 may transmit the uncollected history record every time an execution result is input from execution result receiving portion 261, or may transmit the uncollected history record that consolidates the execution results input for a prescribed period, at prescribed intervals. Alternatively, execution results may be accumulated to reach a prescribed amount, and the uncollected history record that consolidates the prescribed amount of execution results may be transmitted in response to the prescribed amount being reached.

FIG. 8 is a diagram showing an example of the first fee table. Referring to FIG. 8, the first fee table defines a rate for each process. Specifically, the rate for a copy process using A4-size paper is set at 5 yen, the rate for a copy process using A3-size paper is set at 15 yen, and the rate for a copy process using paper other than A4 and A3 is set at 8 yen. The rate for a stapling process is set at 5 yen, the rate for a punching process is set at 5 yen, and the rate for a folding process is set at 5 yen. The rate for an application process for travel expenses management is set at 30 yen, and the rate for any other application process is set at 100 yen.

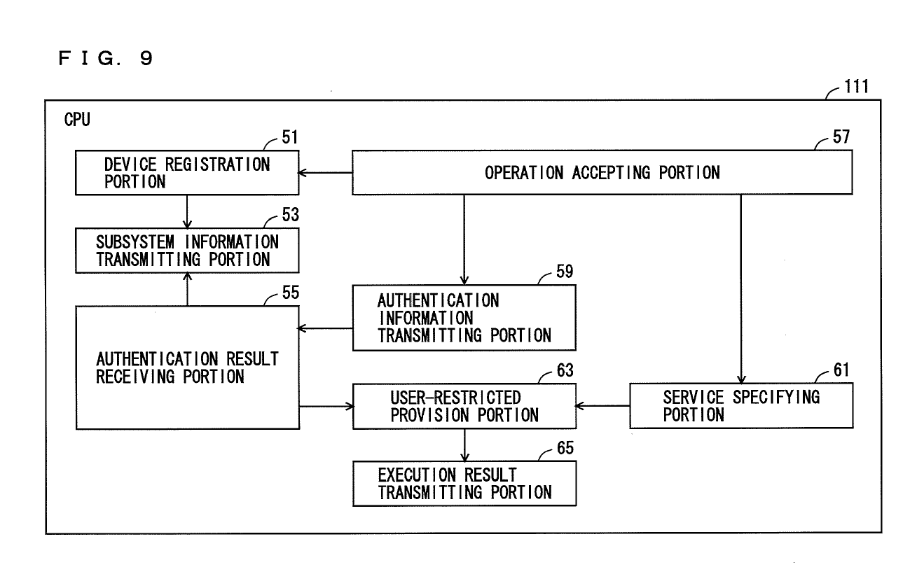

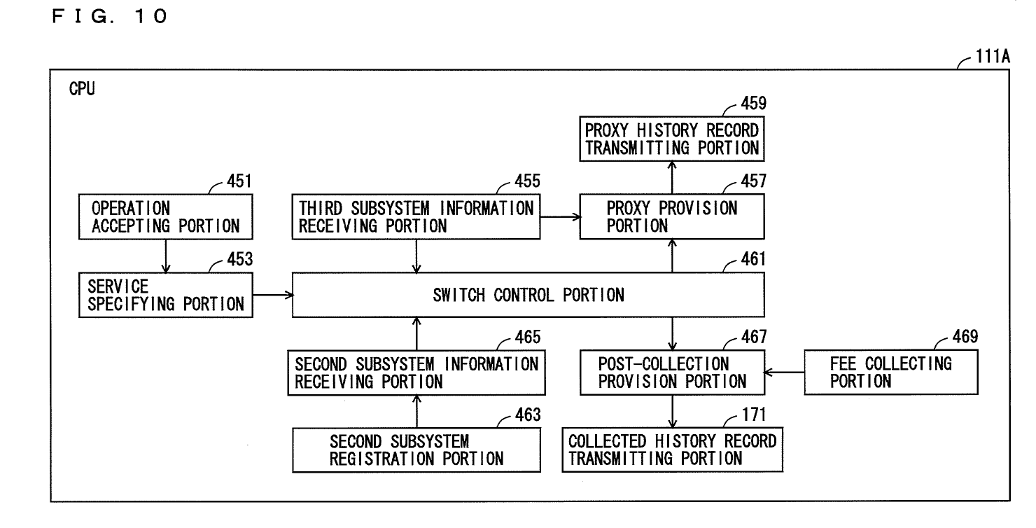

FIG. 9 is a block diagram showing an example of functions of the CPU of the MFP included in the first subsystem. The functions shown in FIG. 9 are implemented by CPU 111 when CPU 111 of each of MFPs 100 and 100A to 100C included in first subsystem 10 executes a program stored in ROM 113, EEPROM 115, HDD 116, or CD-ROM 119A. Here, the functions of CPU 111 of MFP 100 will be described as an example.

Referring to FIG. 9, CPU 111 of MFP 100 includes a device registration portion 51 for registering MFP 100 in first subsystem 10, a subsystem information transmitting portion 53 for receiving the first subsystem information from local server 200, an operation accepting portion 57 for accepting an operation by the user, an authentication information transmitting portion 59 for transmitting authentication information to local server 200, an authentication result receiving portion 55 for receiving an authentication result from local server 200, a service specifying portion 61 for specifying a service based on the operation input by the user, a user-restricted provision portion 63 for providing a specified service, and an execution result transmitting portion 65 for transmitting an execution result of the provided service to local server 200.

Operation accepting portion 57 accepts an operation input by the user to operation unit 160B. Operation accepting portion 57 outputs the accepted operation to device registration portion 51, authentication information transmitting portion 59, and service specifying portion 61.

Device registration portion 51 accepts the network address of local server 200 and a registration instruction that are input by the administrator of MFP 100 to operation unit 160B. The administrator of MFP 100 may be the same person as the administrator of local server 200 or may be a different person. When accepting the network address and the registration instruction, device registration portion 51 transmits a device registration request to local server 200 through communication I/F unit 112. Local server 200, receiving the device registration request, returns the first subsystem information. Then, when communication I/F unit 112 receives the first subsystem information from local server 200, device registration portion 51 outputs the first subsystem information to subsystem information transmitting portion 53.

Authentication information transmitting portion 59 displays a login screen on display unit 160A. When the user inputs user identification information and a password to operation unit 160B in accordance with the login screen, authentication information transmitting portion 59 receives the user identification information and password input from operation accepting portion 57. Authentication information transmitting portion 59 transmits authentication information including the user identification information and password input from operation accepting portion 57 to local server 200 through communication I/F unit 112.

Local server 200 receiving the authentication information returns the authentication result. Then, authentication result receiving portion 55 obtains the authentication result received by communication I/F unit 112 from local server 200. If the authentication result indicates permission, authentication result receiving portion 55 outputs a permission signal to subsystem information transmitting portion 53 and user-restricted provision portion 63. If the authentication result indicates non-permission, authentication result receiving portion 55 outputs a non-permission signal to subsystem information transmitting portion 53 and user-restricted provision portion 63.

On the conditions that communication is established through short-range radio communication portion 118 with portable information device 600 carried by a user and that a permission signal is input from authentication result receiving portion 55, subsystem information transmitting portion 53 transmits the first subsystem information input from device registration portion 51 to portable information device 600 carried by the user. When the user inputs to operation unit 160B an operation to give an instruction to transmit the subsystem information, subsystem information transmitting portion 53 transmits the first subsystem information to portable information device 600 that short-range radio communication unit 118 can communicate with at the time when the operation is input. Here, the user may operate portable information device 600 to allow portable information device 600 to communicate with MFP 100 thereby remotely operating MFP 100 from portable information device 600. In this case, in response to a transmission request received from portable information device 600, subsystem information transmitting portion 53 returns the first subsystem information if a permission signal is input from authentication result receiving portion 55 at that point of time.

Service specifying portion 61 displays a process condition setting screen for setting process conditions on display unit 160A. When the user inputs process conditions to operation unit 160B in accordance with the process condition setting screen, service specifying portion 61 receives the process conditions input from operation accepting portion 57. The process conditions include process identification information for specifying a process, a parameter for executing the process, and the like. Service specifying portion 61 generates a job based on one or more process conditions input from operation accepting portion 57 and outputs the generated job to user-restricted provision portion 63. The job includes process identification information for each of one or more processes and a parameter for executing each of one or more processes.

When a job is input from service specifying portion 61, user-restricted provision portion 63 executes a process in accordance with the job on the condition that a permission signal is input from authentication result receiving portion 55. User-restricted provision portion 63 executes a job by controlling at least one of automatic document feeder 120, document scanning unit 130, image forming unit 140, paper-feeding unit 150, communication I/F unit 112, HDD 116, and facsimile unit 117.

Execution result transmitting portion 65 transmits the execution result of the job executed by user-restricted provision portion 63 to local server 200 through communication I/F unit 112. The execution result includes the process identification information defined by the job and the number of times the process specified by the process identification information is executed.

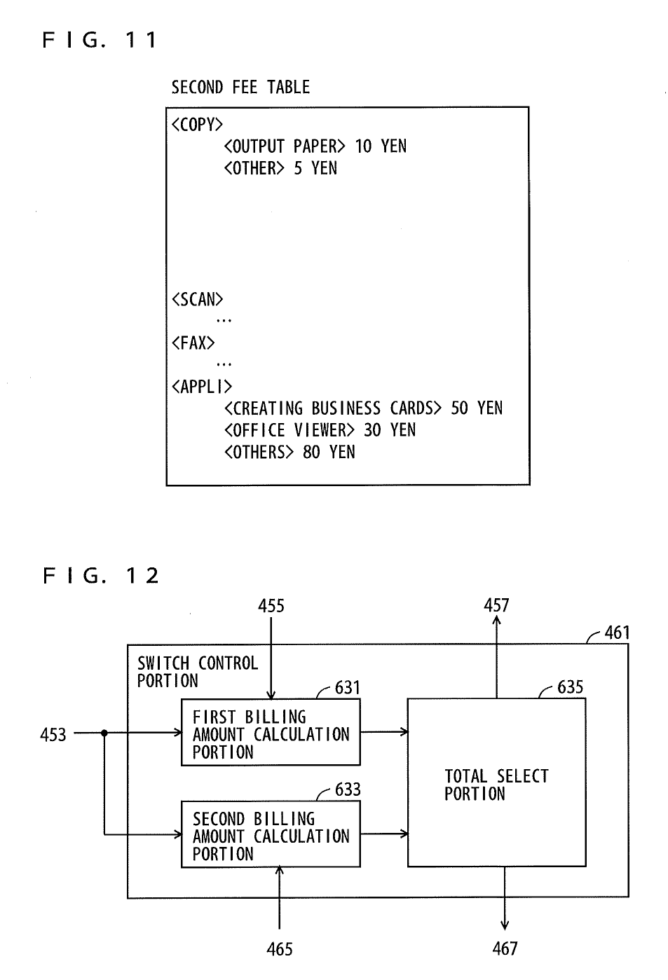

FIG. 10 is a block diagram showing an example of functions of the CPU of the MFP included in the second subsystem. The functions shown FIG. 10 are implemented in CPU 111A when CPU 111A of each of MFPs 400 and 400A included in second subsystems 20 and 20A, respectively, executes a program stored in ROM 113, EEPROM 115, HDD 116, or CD-ROM 119A. Here, the functions of CPU 111A of MFP 400 will be described as an example.

Referring to FIG. 10, CPU 111A of MFP 400 includes an operation accepting portion 451 for accepting an operation by a user, a service specifying portion 453 for specifying a service from the operation input by the user, a third subsystem information receiving portion 455, a second subsystem registration portion 463, a second subsystem information receiving portion 465 for receiving the second fee table from summation server 500, a switch control portion 461, a proxy provision portion 457, a proxy history record transmitting portion 459 for transmitting a proxy history record to summation server 500, a fee collecting portion 469, a post-collection provision portion 467, and a collected history record transmitting portion 471 for transmitting a collected history record to summation server 500.

Operation accepting portion 451 accepts an operation input by the user to operation unit 160B. Operation accepting portion 451 outputs the accepted operation to service specifying portion 453.

Service specifying portion 453 displays a process condition setting screen for setting process conditions on display unit 160A. When the user inputs process conditions to operation unit 160B in accordance with the process condition setting screen, service specifying portion 453 receives the process conditions input from operation accepting portion 57. The process conditions include process identification information for specifying a process, a parameter for executing the process, and the like. Service specifying portion 453 generates a job based on one or more process conditions input from operation accepting portion 451 and outputs the generated job to switch control portion 461. The job includes process identification information for each of one or more processes and a parameter for executing each of one or more processes.

Third subsystem information receiving portion 455 communicates with portable information device 600 carried by a user through short-range radio communication unit 118 and receives the first subsystem information from portable information device 600. Third subsystem information receiving portion 455 outputs the received first subsystem information to switch control portion 461 and outputs the subsystem identification information of first subsystem 10 included in the first subsystem information to proxy provision portion 457. Here, if portable information device 600 has received the first subsystem information from any one of MFPs 100 and 100A to 100C of first subsystem 10, the first subsystem information received by third subsystem information receiving portion 455 includes the subsystem identification information of first subsystem 10 and the first fee table. When the user inputs a system information read request instruction to operation unit 160B, third subsystem information receiving portion 455 receives the first subsystem information from portable information device 600 that short-range radio communication unit 118 can communicate with at the time when the operation is input. Here, the user may operate portable information device 600 to allow portable information device 600 to communicate with MFP 400 thereby remotely operating MFP 400 from portable information device 600. In this case, third subsystem information receiving portion 455 receives the first subsystem information in response to a reception request being received from portable information device 600.

Second subsystem registration portion 463 registers second subsystem 20 in summation server 500. For example, when the administrator of summation server 500 registers second subsystem 20 in summation server 500, summation server 500 assigns the subsystem identification information of second subsystem 20. The administrator of MFP 400 receives a notification of the network address of summation server 500 and the subsystem identification information of second subsystem 20 from the administrator of summation server 500 and inputs them to operation unit 160B. When the network address of summation server 500 and the subsystem identification information of second subsystem 20 are input by the administrator, second subsystem registration portion 463 transmits a registration request to summation server 500 and outputs a reception instruction to second subsystem information receiving portion 465. The reception instruction includes the network address of summation server 500. The registration request includes the subsystem identification information of second subsystem 20.

Upon receiving the registration request, summation server 500 returns the second subsystem information including a set of the subsystem identification information of second subsystem 20 and the second fee table. Then, when communication I/F unit 112 receives the subsystem information from summation server 500 specified by the network address included in the reception instruction input from second subsystem registration portion 463, second subsystem information receiving portion 465 obtains the received second subsystem information and outputs the second subsystem information to switch control portion 461.

Switch control portion 461 receives a job input from service specifying portion 453, the first subsystem information input from third subsystem information receiving portion 455, and the second subsystem information input from second subsystem information receiving portion 465. Switch control portion 461 allows proxy provision portion 457 or post-collection provision portion 467 to execute a process specified by each of one or more process identification information included in the job input from service specifying portion 453.

Switch control portion 461 compares the first fee table included in the first subsystem information with the second fee table included in the second subsystem information and then allows one of proxy provision portion 457 and post-collection provision portion 467 to execute a process. In the case where proxy provision portion 457 is allowed to execute a process, switch control portion 461 outputs the process identification information and the parameter to proxy provision portion 457. In the case where post-collection provision portion 467 is allowed to execute a process, switch control portion 461 outputs the second fee table, the process identification information, and the parameter to post-collection provision portion 467.

Fee collecting portion 469 controls coin vendor 405 to obtain the amount of deposited money in coin vendor 405 to output the deposited amount to post-collection provision portion 467. When a collection instruction is input from post-collection provision portion 467, fee collecting portion 469 collects the fee included in the collection instruction from the amount deposited in coin vendor 405 and changes the amount of deposited money to the remaining amount.

Post-collection provision portion 467 receives the second fee table, process identification information, and parameter input from switch control portion 461 and the amount of deposited money from fee collecting portion 469. Post-collection provision portion 467 refers to the second fee table to obtain the rate corresponding to the process identification information and calculates the fee for executing the process specified by the process identification information. Post-collection provision portion 467 executes the process specified by the process identification information on the condition that the amount deposited in coin vendor 405 is equal to or greater than the calculated fee. Post-collection provision portion 467 executes the process by controlling at least one of automatic document feeder 120, document scanning unit 130, image forming unit 140, paper-feeding unit 150, communication I/F unit 112, HDD 116, and facsimile unit 117.

Collected history record transmitting portion 471 transmits a collected history record including the execution result of the process executed by post-collection provision portion 467 to summation server 500 through communication I/F unit 112.

Proxy provision portion 457 receives the process identification information and parameter input from switch control portion 461 and the subsystem identification information of first subsystem 10 input from third subsystem information receiving portion 455. Proxy provision portion 457 executes the process specified by the process identification information and outputs the subsystem identification information of first subsystem 10 to proxy history record transmitting portion 459. Proxy provision portion 457 executes the process by controlling at least one of automatic document feeder 120, document scanning unit 130, image forming unit 140, paper-feeding unit 150, communication I/F unit 112, HDD 116, and facsimile unit 117.

Proxy history record transmitting portion 459 transmits a proxy history record including the execution result of the process executed by proxy provision portion 457 and the subsystem identification information of first subsystem 10 input from proxy provision portion 457, to summation server 500 through communication I/F unit 112.

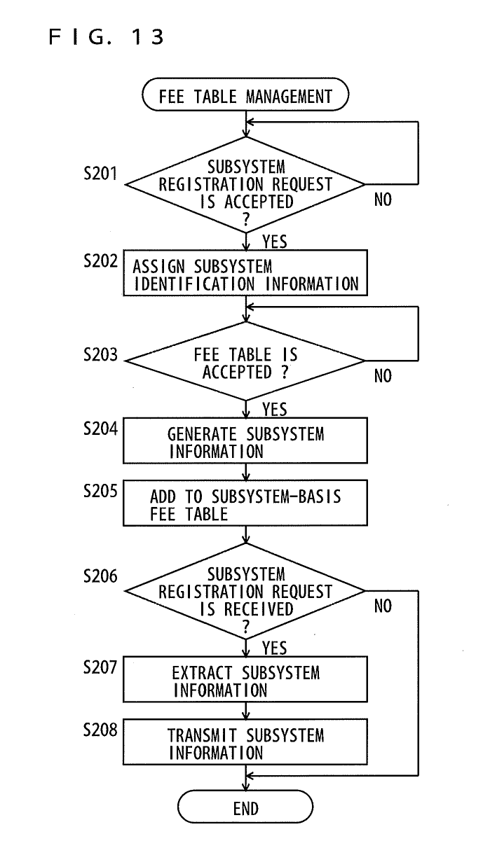

FIG. 11 is a diagram showing an example of the second fee table. Referring to FIG. 11, the second fee table defines a rate for each process. Specifically, the rate for a copy process using every kind of paper is set at 10 yen, and the rate for any other copy process is set at 5 yen. The rate for an application process for creating business cards is set at 50 yen, the rate for an application process for Office Viewer is set at 30 yen, and the rate for any other application process is set at 80 yen.

FIG. 12 is a diagram showing details of exemplary functions of the switch control portion. Referring to FIG. 12, switch control portion 461 includes a first billing amount calculation portion 631, a second billing amount calculation portion 633, and a total select portion 635.

First billing amount calculation portion 631 receives a job input from service specifying portion 453 and the first subsystem information input from third subsystem information receiving portion 455. First billing amount calculation portion 631 refers to the first fee table included in the first subsystem information to calculate the first total billing amount for executing all of one or more processes included in the job input from service specifying portion 453. First billing amount calculation portion 631 outputs the calculated first total billing amount to total select portion 635.

Second billing amount calculation portion 633 receives a job input from service specifying portion 453 and the second subsystem information input from second subsystem information receiving portion 465. Second billing amount calculation portion 633 refers to the second fee table included in the second subsystem information to calculate the second total billing amount for executing all of one or more processes included in the job input from service specifying portion 453. Second billing amount calculation portion 631 outputs the calculated second total billing amount to total select portion 635.

Total select portion 635 compares the first total billing amount input from first billing amount calculation portion 631 with the second total billing amount input from second billing amount calculation portion 633 and then allows proxy provision portion 457 or post-collection provision portion 467 to execute all of one or more processes included in the job input from service specifying portion 453. If the first total billing amount is smaller than the second total billing amount, total select portion 635 decides on proxy provision portion 457. If the second total billing amount is equal to or smaller than the first total billing amount, total select portion 635 decides on post-collection provision portion 467. When post-collection provision portion 467 is decided on, total select portion 635 outputs a set of process identification information and parameters of all of one or more processes included in the job input from service specifying portion 453 to post-collection provision portion 467. When proxy provision portion 457 is decided on, total select portion 635 outputs a set of process identification information and parameters of all of one or more processes included in the job input from service specifying portion 453 to proxy provision portion 457.

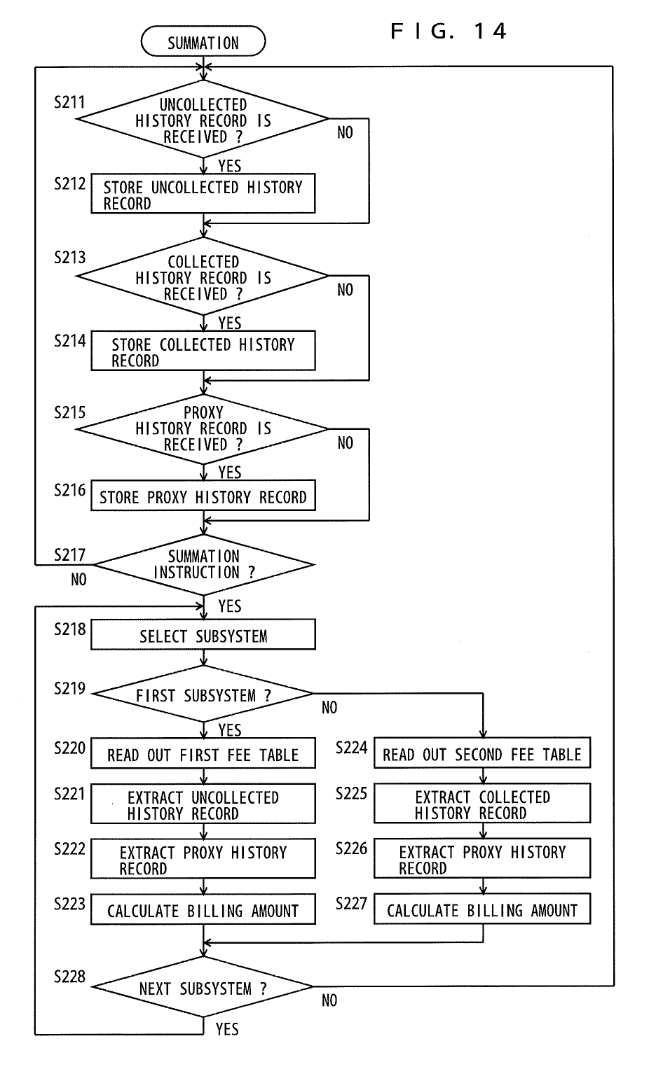

FIG. 13 is a flowchart showing an exemplary flow of a fee table management process. The fee table management process is a process executed by CPU 501 by CPU 501 of summation server 500 executing a program stored in ROM 503, HDD 507, or CD-ROM 515A. Referring to FIG. 13, CPU 501 determines whether a request for registering a subsystem is accepted (S201). When the administrator of summation server 500 inputs an instruction to register a subsystem to operation unit 511, a request for registering a subsystem is accepted. The administrator of summation server 500 determines by authenticating a user. The process waits until a request for registering a subsystem is accepted (NO in step S201). If a request for registering a subsystem is accepted (YES in step S201), the process proceeds to step S202.

In step S202, subsystem identification information is assigned. In the next step S203, a fee table is accepted. The fee table input by the administrator to operation unit 511 may be accepted, or the fee table stored in CD-ROM 515A may be read out from external storage device 515, or the fee table may be downloaded through communication I/F 513 from a computer connected to the Internet 3. The process waits until a fee table is accepted (NO in step S203). If a fee table is accepted (YES in step S203), the process proceeds to step S204.

In step S204, subsystem information is generated. The subsystem information includes the subsystem identification information assigned in step S202 and the fee table accepted in step S203. In the next step S205, the subsystem information generated in step S204 is stored additionally in subsystem-basis fee table 561 stored in HDD 507.

In the next step S206, it is determined whether a subsystem registration request is received. It is determined whether communication I/F 513 receives a subsystem registration request from any one of local server 200 of first subsystem 10, MFPs 400 and 400A of second subsystems 20 and 20A, and communication device 410 of second subsystem 20B. The subsystem registration request includes subsystem identification information. If a subsystem registration request is received, the process proceeds to step S207. If not, the process ends.

In step S207, the subsystem information including the subsystem identification information included in the received subsystem registration request is read out from subsystem-basis fee table 561 stored in HDD 507. Then, the read-out subsystem information is returned to the device that has transmitted the subsystem registration request, through communication I/F 513 (step S208). The process then ends.

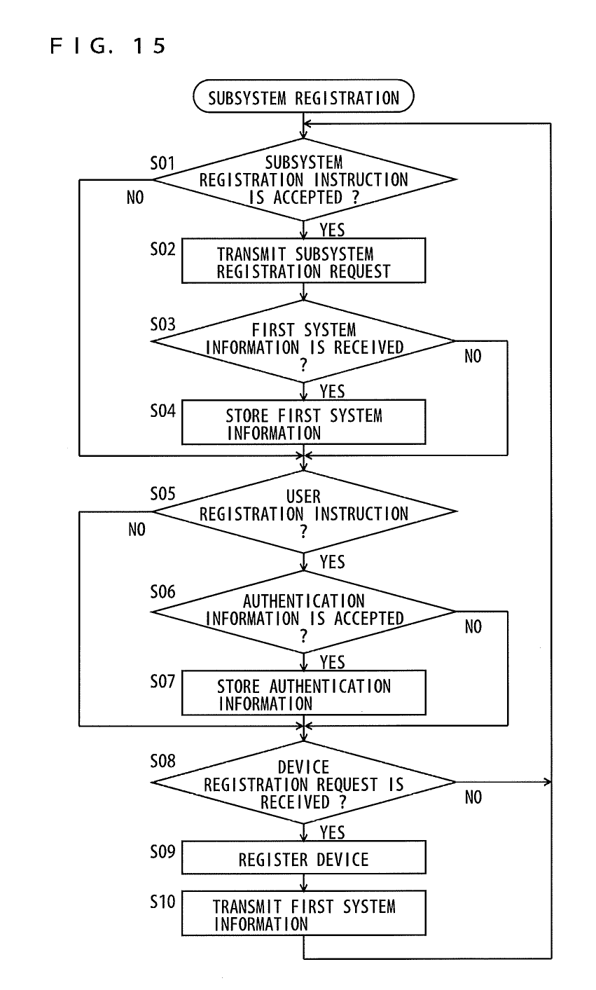

FIG. 14 is a flowchart showing an exemplary flow of a summation process. The summation process is a process executed by CPU 501 by CPU 501 of summation server 500 executing a program stored in ROM 503, HDD 507, or CD-ROM 515A. Referring to FIG. 14, CPU 501 determines whether an uncollected history record is received (step S211). It is determined whether communication I/F 513 receives an uncollected history record from local server 200 of first subsystem 10. If an uncollected history record is received, the process proceeds to step S212. If not, step S212 is skipped, and the process proceeds to step S213. In step S212, the received uncollected history record is stored in HDD 507 in association with the system identification information of first subsystem 10 pertinent to local server 200 that has transmitted the uncollected history record. The process then proceeds to step S213.

In step S213, it is determined whether a collected history record is received. It is determined whether communication I/F 513 receives a collected history record from any one of MFPs 400 and 400A of second subsystems 20 and 20A and communication device 410 of second subsystem 20B. If a collected history record is received, the process proceeds to step S214. If not, step S214 is skipped, and the process proceeds to step S215. In step S214, the received collected history record is stored in HDD 507 in association with the system identification information of the second subsystem pertinent to the device that has transmitted the collected history record. The process then proceeds to step S215. If the collected history record is received from MFP 400, it is stored in association with the subsystem identification information of second subsystem 20. If the collected history record is received from MFP 400A, it is stored in association with the subsystem identification information of second subsystem 20A. If the collected history record is received from communication device 410, it is stored in association with the subsystem identification information of second subsystem 20B.

In step S215, it is determined whether a proxy history record is received. It is determined whether communication I/F 513 receives a proxy history record from any one of MFPs 400 and 400A of second subsystems 20 and 20A and communication device 410 of second subsystem 20B. If a proxy history record is received, the process proceeds to step S216. If not, step S216 is skipped, and the process proceeds to step S217. In step S216, the received proxy history record is stored in HDD 507 in association with the system identification information of the second subsystem pertinent to the device that has transmitted the proxy history record. The process then proceeds to step S217. If a proxy history record is received from MFP 400, it is stored in association with the subsystem identification information of second subsystem 20. If a proxy history record is received from MFP 400A, it is stored in association with the subsystem identification information of second subsystem 20A. If a proxy history record is received from communication device 410, it is stored in association with the subsystem identification information of second subsystem 20B.

In step S217, it is determined whether a summation instruction is accepted. A summation instruction is accepted when a predetermined date and time has come. A predetermined date and time is, for example, a predetermined time at the end of every month. The administrator of summation server 500 may input a summation instruction to operation unit 511. If a summation instruction is accepted, the process proceeds to step S218. If not, the process returns to step S211.

In step S218, a subsystem targeted for summation is selected. Then, it is determined whether the selected subsystem is the first subsystem (step S219). It is determined whether the subsystem identification information of the selected subsystem is the same as the subsystem identification information of first subsystem 10. If the selected subsystem is the first subsystem, the process proceeds to step S220. If not, the process proceeds to step S224.

In step S220, the first fee table of the selected subsystem is read out. Specifically, the first fee table included in the subsystem information including the subsystem identification information of the selected subsystem is read out from subsystem-basis fee table 561 stored in HDD 507.

In the next step S221, the uncollected history record associated with the subsystem identification information of the subsystem selected in step S218 is extracted from among the uncollected history records stored in HDD 507 in step S212. In the next step S222, the proxy history record including the subsystem identification information of the subsystem selected in step S218 is extracted from among the proxy history records stored in HDD 507 in step S215.

In the next step S233, the billing amount is calculated, and the process then proceeds to step S228. The total number of times of execution for each process is calculated by integrating the number of times of execution of the same process identification information, using the execution result included in the uncollected history record extracted in step S221 and the execution result included in the proxy history record extracted in step S222. Then, the billing amount is calculated by multiplying the number of times of execution for each of a plurality of processes by the associated rate in the first fee table read out in step S220.

In step S224, the second fee table of the selected subsystem is read out. Specifically, the second fee table included in the subsystem information including the subsystem identification information of the selected subsystem is read out from subsystem-basis fee table 561 stored in HDD 507.

In the next step S225, the collected history record associated with the subsystem identification information of the subsystem selected in step S218 is extracted from among the collected history records stored in HDD 507 in step S214. In the next step S225, the proxy history record associated with the subsystem identification information of the subsystem selected in step S218 is extracted from among the proxy history records stored in HDD 507 in step S216.

In the next step S227, the billing amount is calculated, and the process then proceeds to step S228. The total number of times of execution for each process is calculated by integrating the number of times of execution of the same process identification information, using the execution result included in the collected history record extracted in step S225 and the execution result included in the proxy history record extracted in step S226. Then, the virtual billing amount is calculated by multiplying the number of times of execution for each of a plurality of processes by the associated rate in the second fee table read out in step S224. Here, assuming that the agreement each between business operator A and business operators C, D and E stipulates that a prescribed proportion, for example, 30% of the virtual billing amount should be paid from business operator B to business operator A, 30% of the virtual billing amount is calculated as the amount billed to business operator B by business operator A.

In step S228, it is determined whether there exists any subsystem not yet targeted for summation. If there exists a subsystem not yet targeted for summation, the process returns to step S218. If none exists, the process returns to step S211. When the process returns to step S211, the uncollected history records, collected history records, and proxy history record stored in HDD 507 are erased from HDD 507, or are marked to indicate that they have been summed in order to exclude them from the next targets for summation. In the case where the uncollected history records, collected history records, and proxy history records are stored in HDD 507 with the addition of the date, month, and year, the history records targeted for summation can be narrowed down by a period.

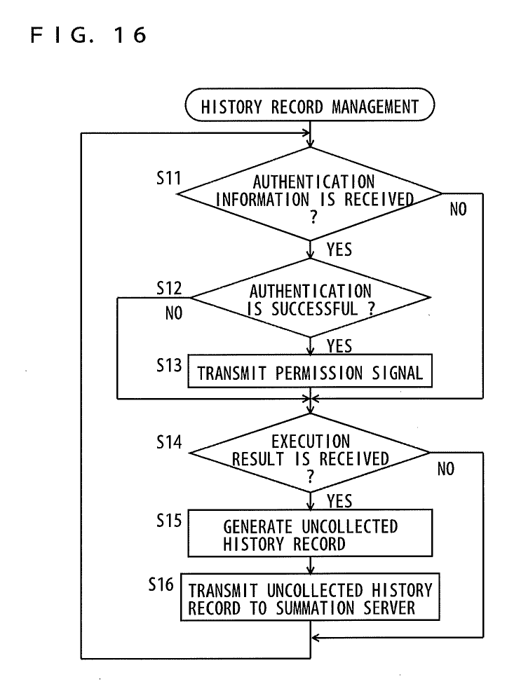

FIG. 15 is a flowchart showing an exemplary flow of a subsystem registration process. The subsystem registration process is a process executed by CPU 201 by CPU 201 of local server 200 executing a program stored in ROM 203, HDD 207, or CD-ROM 215A.

Referring to FIG. 15, CPU 201 determines whether a subsystem registration instruction is accepted (step S01). A subsystem registration instruction is accepted if the administrator of local server 200 inputs the network address of summation server 500 and the subsystem identification information of first subsystem 10 to operation unit 211. If a subsystem registration instruction is accepted, the process proceeds to step S02. If not, the process proceeds to step S05.

In step S02, a subsystem registration request is transmitted to summation server 500. Then, it is determined whether the first subsystem information is received from summation server 500 (step S03). If communication I/F 213 receives the first subsystem information from summation server 500, the process proceeds to step S04. If not, step S04 is skipped, and the process proceeds to step S05. In step S04, the received first system information is stored in HDD 207. The process then proceeds to step S05.

In step S05, it is determined whether a user registration instruction is accepted. If a user registration instruction is accepted, the process proceeds to step S06. If not, the process proceeds to step S08. In step S06, it is determined whether authentication information is accepted. If authentication information is accepted, the process proceeds to step S07. If not, step S07 is skipped, and the process proceeds to step S08. The authentication information includes user identification information for identifying a user capable of using first subsystem 10 and a password. The authentication information input to operation unit 211 by the administrator of local server 200 is accepted. In step S07, the accepted authentication information is stored in HDD 207. Here, a user record including the authentication information is stored additionally in the user table stored in HDD 207 in advance.

In step S08, it is determined whether a device registration request is received. It is determined whether communication I/F 213 receives a device registration request from any one of MFPs 100 and 100A to 100C. If a device registration request is received, the process proceeds to step S09. If not, the process returns to step S01. In step S09, the device that has transmitted a device registration request is registered in first subsystem 10. Specifically, the network address of the MFP that has transmitted a device registration request, among MFPs 100 and 100A to 100C, is stored into HDD 207 as the network address of an image processing apparatus included in first subsystem 10.

In the next step S10, the first subsystem information stored in HDD 207 in step S04 is transmitted to the MFP that has transmitted a device registration request, among MFPs 100 and 100A to 100C. The process then returns to step S01.

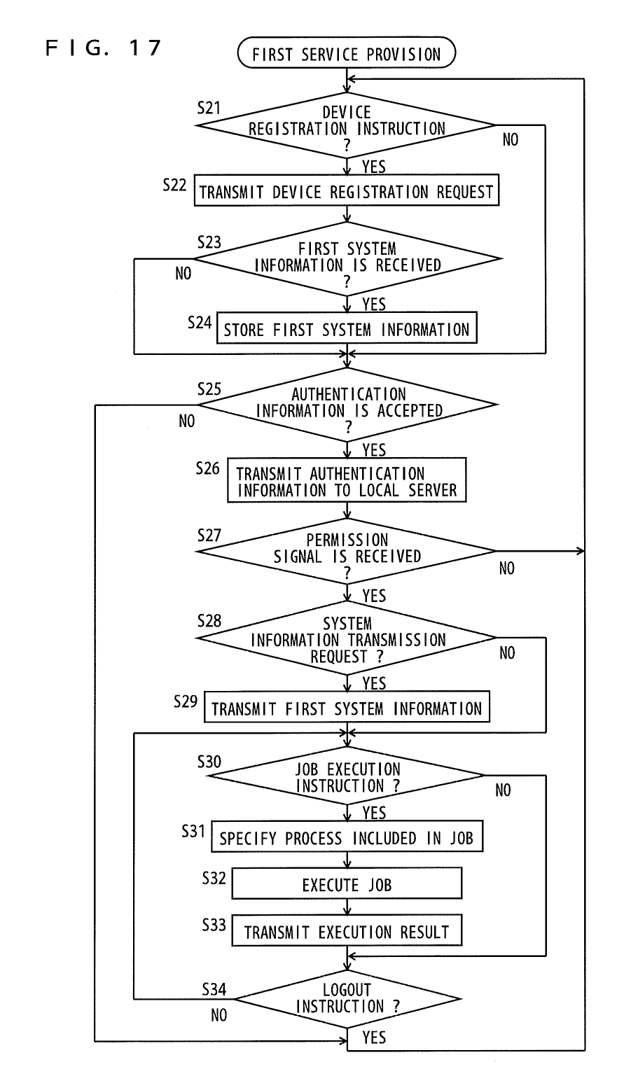

FIG. 16 is a flowchart showing an exemplary flow of a history record management process. The history record management process is a process executed by CPU 201 by CPU 201 of local server 200 executing a program stored in ROM 203, HDD 207, or CD-ROM 215A.

Referring to FIG. 16, CPU 201 determines whether authentication information is received (step S11). It is determined whether communication I/F 213 receives authentication information from any one of MFPs 100 and 100A to 100C. If authentication information is received, the process proceeds to step S12. If not, the process proceeds to step S14.

In step S12, authentication is performed based on the authentication information received in step S11, and it is determined whether authentication is successful. The authentication information of the user permitted to use is stored in HDD 207 in step S07 in FIG. 15. Thus, if the same authentication information as the authentication information received in step S11 is stored in HDD 207, authentication is successful. If the same authentication information is not stored in HDD 207, authentication is failed. If authentication is successful, the process proceeds to step S13. If authentication is failed, step S13 is skipped, and the process proceeds to step S14. In step S13, a permission signal is transmitted to the device that has transmitted the authentication information. The process then proceeds to step S14. A permission signal is transmitted to the MFP that has transmitted the authentication information, among MFPs 100 and 100A to 100C, through communication I/F 213.

In step S14, it is determined whether communication I/F 213 receives an execution result from any one of MFPs 100 and 100A to 100C. If an execution result is received, the process proceeds to step S15. If not, the process returns to step S11.

In step S15, an uncollected history record is generated. The uncollected history record includes the subsystem identification information of first subsystem 10 pertinent to local server 200 and the execution result received in step S14. Then, the generated uncollected history record is transmitted to summation server 500 through communication I/F 213 (step S16). The process then returns to step S11.

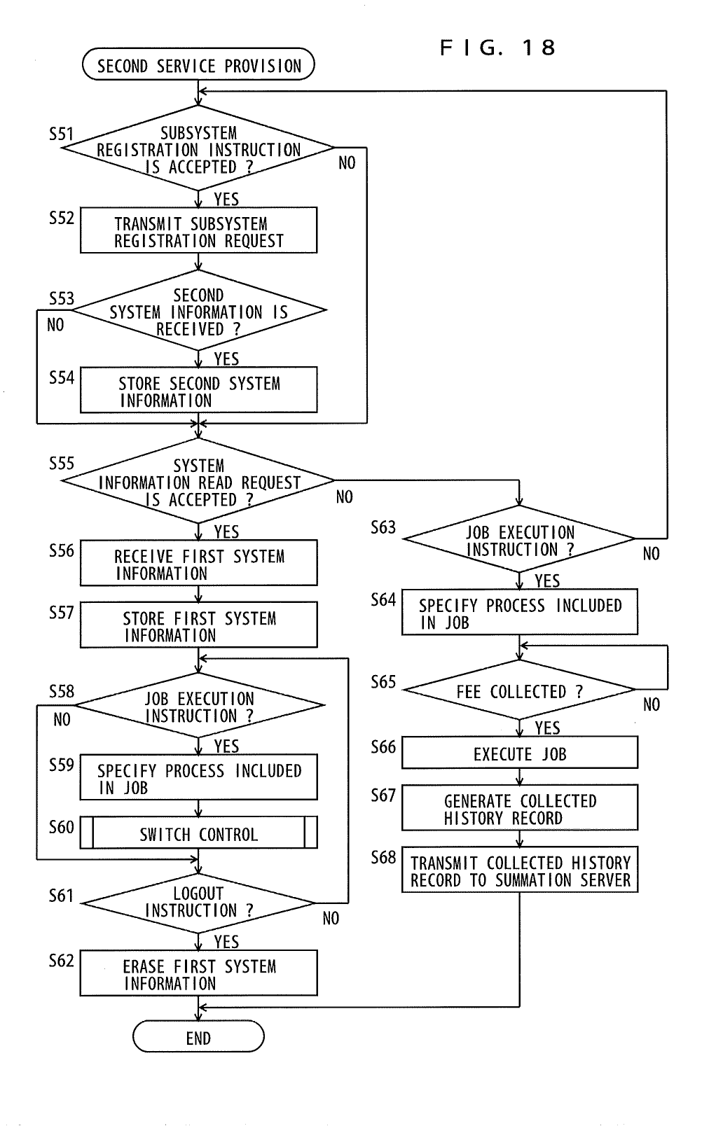

FIG. 17 is a flowchart showing an exemplary flow of a first service provision process. The first service provision process is a process executed by CPU 111 when CPU 111 of each of MFPs 100 and 100A to 100C included in first subsystem 10 executes a program stored in ROM 113, EEPROM 115, HDD 116, or CD-ROM 119A. Here, the first service provision process executed by CPU 111 of MFP 100 will be described as an example.

CPU 111 determines whether a device registration instruction is accepted (step S21). A registration instruction is accepted when the administrator of MFP 100 inputs the network address of local server 200 and a registration instruction to operation unit 160B. If a device registration instruction is accepted, the process proceeds to step S22. If not, the process proceeds to step S25. In step S22, the device registration request is transmitted to local server 200 through communication I/F unit 112.

Then, it is determined whether the first system information is received from local server 200 (step S23). If communication I/F unit 112 receives the first system information from local server 200, the process proceeds to step S25. If not, step S24 is skipped, and the process proceeds to step S25. In step S24, the first system information received in step S23 is stored in HDD 116. The process then proceeds to step S25.

In step S25, it is determined whether authentication information is accepted. Authentication information is accepted if the user who operates MFP 100 inputs user identification information and a password to operation unit 160B. If authentication information is accepted, the process proceeds to step S26. If not, the process returns to step S21. In step S26, the authentication information is transmitted to local server 200 through communication I/F unit 112 for authentication by local server 200. If authentication is successful, local server 200 returns a permission signal. Then, in step S28, it is determined whether communication I/F unit 112 receives a permission signal from local server 200. If a permission signal is received, the process proceeds to step S28. If not, the process returns to step S21. This is done to restrict users capable of using MFP 100 to those registered in advance.

In the next step S28, it is determined whether short-range radio communication unit 118 receives a system information transmission request from portable information device 600 capable of communication. If short-range radio communication unit 118 receives a system information transmission request, the process proceeds to step S29. If not, step S29 is skipped, and the process proceeds to step S30. In step S29, the first system information stored in HDD 116 in step S24 is transmitted to portable information device 600 through short-range radio communication unit 118. Accordingly, the first system information can be downloaded to portable information device 600 carried by the user authenticated in step S27. Step S29 is performed on the condition that the user who operates MFP 100 is authenticated in step S27. Therefore, portable information device 600 to which the first system information can be downloaded can be restricted to portable information device 600 carried by the user registered in advance.

In step S30, it is determined whether a job execution instruction is accepted. If a job execution instruction is accepted, the process proceeds to step S31. If not, the process proceeds to step S34. A process condition setting screen for setting process conditions is displayed on display unit 160A, and when the user inputs process conditions to operation unit 160B in accordance with the process condition setting screen, the process conditions are input from operation accepting unit 57. The process conditions include process identification information for specifying a process, a parameter for executing the process, and the like. When one or more process conditions are input to operation unit 160B and the start key provided in operation unit 160B is pressed, a job execution instruction is accepted. A job is generated based on one or more process conditions input to operation unit 160B before the start key is pressed.

In step S31, a process included in the job designated for execution in step S30 is specified. Then, in the next step S32, the job generated in step S30 is executed. In the next step S33, the execution result is transmitted to local server 200 through communication I/F unit 112. The execution result includes the process identification information of the process specified in step S31 and the number of time the process is executed. If the job includes a plurality of processes, a plurality of processes are executed in step S32. In step S34, the execution result including the respective process identification information of a plurality of processes and the number of times of execution thereof is transmitted.

In step S34, it is determined whether a logout instruction is accepted. A logout instruction is accepted if the user inputs a logout instruction to operation unit 160B. If a logout instruction is accepted, the process returns to step S21. If not, the process returns to step S30.

FIG. 18 is a flowchart showing an exemplary flow of a second service provision process. The second service provision process is a process executed by CPU 111A when CPU 111A of each of MFPs 400 and 400A included in second subsystem 20 and 20A, respectively, executes a program stored in ROM 113, EEPROM 115, HDD 116, or CD-ROM 119A. Here, a second service provision process executed by CPU 111A of MFP 400 will be described as an example.

Referring to FIG. 18, CPU 111A determines whether a subsystem registration instruction is accepted (step S51). A subsystem registration instruction is accepted if the administrator of MFP 400 inputs the network address of summation server 500 and the subsystem identification information of second subsystem 20 to operation unit 160B. If a subsystem registration instruction is accepted, the process proceeds to step S52. If not, the process proceeds to step S55.

In step S52, a subsystem registration request is transmitted to summation server 500. Then, it is determined whether the second subsystem information is received from summation server 500 (step S53). If communication I/F unit 112 receives the second subsystem information from summation server 500, the process proceeds to step S54. If not, step S54 is skipped, and the process proceeds to step S55. In step S54, the received second system information is stored into HDD 116. The process then proceeds to step S55.

In step S55, it is determined whether a system information read request is accepted. A system information read request is accepted if the user inputs a system information read request instruction to operation unit 160B. If a system information read request is accepted, the process proceeds to step S56. If not, the process proceeds to step S63. In step S56, the first system information is received. If there exists portable information device 600 that short-range radio communication unit 118 can communicate with, the first subsystem information is received from that portable information device 600. In step S57, the first system information received in step S56 is stored into HDD 116. The process then proceeds to step S58. At this stage, public authentication is performed by permitting login of the user who uses MFP 400, using the device identification information of portable information device 600.

In step S58, it is determined whether a job execution instruction is accepted. If a job execution instruction is accepted, the process proceeds to step S59. If not, the process proceeds to step S61. A process condition setting screen for setting process conditions is displayed on display unit 160A, and when the user inputs process conditions to operation unit 160B in accordance with the process condition setting screen, the process conditions are input from operation accepting portion 57. The process conditions include process identification information for identifying a process, a parameter for executing the process, and the like. When one or more process conditions are input to operation unit 160B and the start key provided in operation unit 160B is pressed, a job execution instruction is accepted. A job is generated based on one or more process conditions input to operation unit 160B before the start key is pressed.

In step S59, a process included in the job designated for execution in step S58 is specified. In the next step S60, a switch control process is executed, and the process then proceeds to step S61. The switch control process will be detailed later.

In step S61, it is determined whether a logout instruction is accepted. A logout instruction is accepted if the user inputs a logout instruction to operation unit 160B. If a logout instruction is accepted, the process proceeds to step S62. If not, the process returns to step S58. In step S62, the login by public authentication in step S56 is cleared, and the first system information stored in HDD 116 in step S57 is erased. The process then ends. This is done to prevent the next user who uses MFP 400 from using the first system information.

On the other hand, in step S63, similar to step S58, it is determined whether a job execution instruction is accepted. If a job execution instruction is accepted, the process proceeds to step S64. If not, the process returns to step S51.

In step S64, a process included in the job designated for execution in step S63 is specified. In the next step S65, it is determined whether a fee for executing the job is collected. The billing amount for executing the process specified in step S64 is calculated using the second fee table included in the second system information stored in HDD 116 in step S54. If the amount of money deposited in coin vendor 405 is greater than the calculated billing amount, the fee is collected by subtracting the billing amount from the amount of deposited money. The process waits until money in the amount equal to or greater than the billing amount is put into coin vendor 405 (NO in step S65). If money in the amount equal to or greater than the billing amount is put into coin vendor 405, the fee is collected. The process then proceeds to step S66.

In step S66, the job generated in step S63 is executed. In the next step S67, a collected history record is generated. The collected history record includes the process identification information of the process specified in step S64 and the number of times the process is executed. Then, the generated collected history record is transmitted to summation server 500 through communication I/F unit 112. The process then ends.

FIG. 19 is a flowchart showing an exemplary flow of the switch control process. The switch control process is a process executed in step S60 shown in FIG. 18. Referring to FIG. 18, CPU 111A calculates the first total billing amount (step S71). Specifically, the first fee table stored in HDD 116 is read out, and the first total billing amount for executing all of one or more processes specified in step S59 in FIG. 18 is calculated.

In the next step S72, the second total billing amount is calculated. Specifically, the second fee table stored in HDD 116 is read out, and the second total billing amount for executing all of one or more processes specified in step S59 in FIG. 18 is calculated.

It is determined whether the first total billing amount is smaller than the second total billing amount (step S73). If the first total billing amount is smaller than the second total billing amount, the process proceeds to step S74. If not, the process proceeds to step S77.

In step S74, the job generated in step S59 in FIG. 18 is executed. In the next step S75, a proxy history record is generated. The proxy history record includes the execution result including the process identification information of the process specified in step S59 in FIG. 18 and the number of times the process is executed, and the subsystem identification information of first subsystem 10. Then, the generated proxy history record is transmitted to summation server 500 through communication I/F unit 112. The process then returns to the second service provision process.

On the other hand, the process in step S77 to step S89 is the same as the process in step S65 to step S68 in FIG. 6. Therefore, the description will not be repeated here.

### First Modification

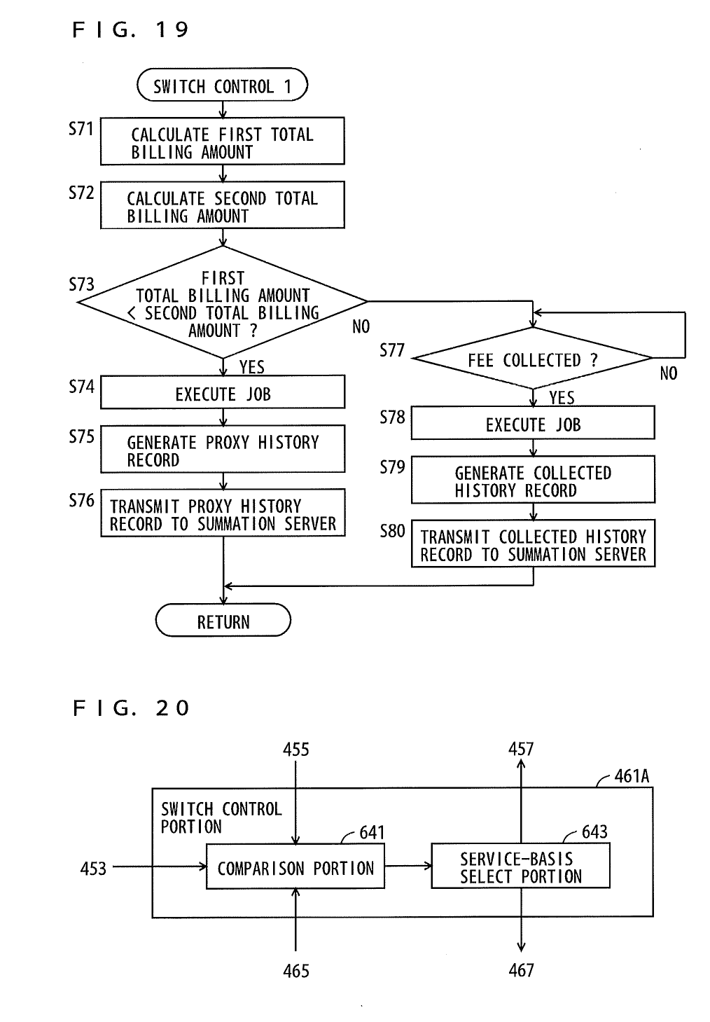

FIG. 20 is a diagram showing details of exemplary functions of a switch control portion according to a first modification. Referring to FIG. 20, a switch control portion 461A in the first modification includes a comparison portion 641 and a service-basis select portion 643.

Comparison portion 641 receives a job input from service specifying portion 453, the first subsystem information input from third subsystem information receiving portion 455, and the second subsystem information input from second subsystem information receiving portion 465. Comparison portion 641 compares the rate defined by the first fee table with the rate defined by the second fee table for the process of the same process identification information, and outputs the comparison result to service-basis select portion 643.

Service-basis select portion 643 decides which of proxy provision portion 457 and post-collection provision portion 467 will execute each of one or more processes included in the job input from service specifying portion 453, based on the comparison result input from comparison portion 641. Service-basis select portion 643 decides on proxy provision portion 457 for a process with the process identification information in which the rate in the first fee table is smaller than the rate in the second fee table, of one or more processes included in the job input from service specifying portion 453. Service-basis select portion 643 decides on post-collection provision portion 467 for a process with the process identification information in which the rate in the second fee table is equal to or smaller than the rate in the first fee table, of one or more processes included in the job input from service specifying portion 453.

For each of one or more processes included in the job input from service specifying portion 453, when post-collection provision portion 467 is decided on, service-basis select portion 643 outputs a set of the process identification information and the parameter of the process to post-collection provision portion 467. When proxy provision portion 457 is decided on, service-basis select portion 643 outputs a set of the process identification information and the parameter of the process to proxy provision portion 457.

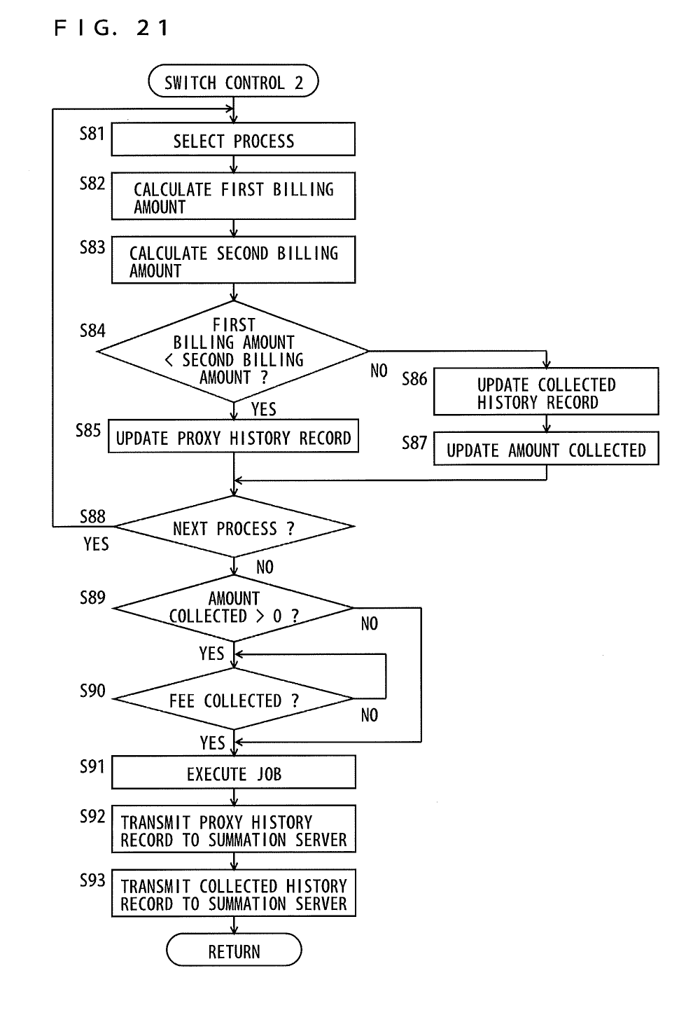

FIG. 21 is a flowchart showing an exemplary flow of a switch control process in the first modification. The switch control process in the first modification is a process executed in step S60 shown in FIG. 18. Referring to FIG. 21, CPU 111A selects one of one or more processes specified in step S59 in FIG. 18, as a process target (step S81).

In the next step S82, the first billing amount for executing the process selected as a process target is calculated. Specifically, the first fee table stored in HDD 116 is read out, and the first billing amount for executing the process selected in step S81 is calculated.

In the next step S83, the second billing amount for executing the process selected as a process target is calculated. Specifically, the second fee table stored in HDD 116 is read out, and the second billing amount for executing the process selected in step S83 is calculated.

In the next step S84, it is determined whether the first billing amount is smaller than the second billing amount. If the first billing amount is smaller than the second billing amount, the process proceeds to step S85. If not, the process proceeds to step S86.

In step S85, the proxy history record is updated, and the process then proceeds to step S88. The proxy history record includes the execution result including the process identification information of the process selected in step S81 and the number of times the process is executed, and the subsystem identification information of first subsystem 10.

On the other hand, in step S86, the collected history record is updated. The collected history record includes the execution result including the process identification information of the process selected in step S81 and the number of times the process is executed. In the next step S87, the amount collected is updated, and the process then proceeds to step S88. The second billing amount calculated in step S83 is added to the amount collected.

In step S88, it is determined whether there exists a process not yet selected as a process target in step S81, among one or more processes specified in step S59 in FIG. 18. If a process not yet selected exists, the process returns to step S81. If none exists, the process proceeds to step S89.

In step S89, it is determined whether the amount collected is greater than zero. The amount collected is zero in a case where step S86 is never performed. If the amount collected is greater than zero, the process proceeds to step S90. If not, the process proceeds to step S91. In step S90, similar to step S65 in FIG. 18, it is determined whether the fee is collected. If the amount equal to or greater than the amount collected is deposited in coin vendor 405, the fee is collected. The process then proceeds to step S91.

In step S91, the job generated in step S58 in FIG. 18 is executed. In the next step S92, the proxy history record updated in step S85 is transmitted to summation server 500 through communication I/F unit 112. In the next step S93, the collected history record updated in step S86 is transmitted to summation server 500 through communication I/F unit 112. The process then returns to the second service provision process.

### Second Modification

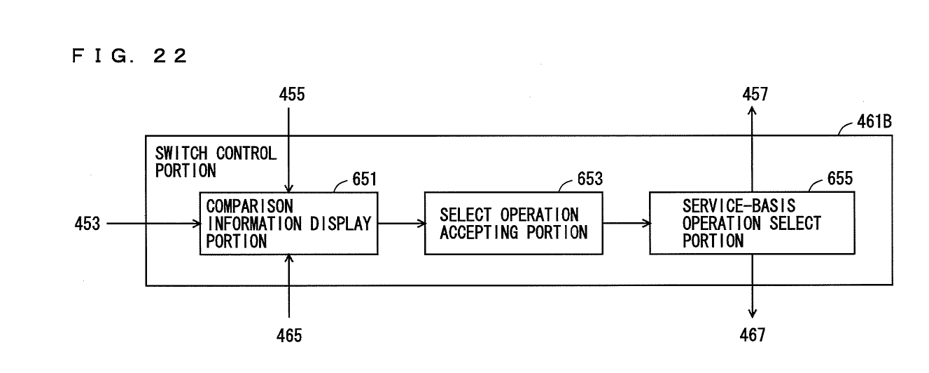

FIG. 22 is a diagram showing details of exemplary functions of a switch control portion according to a second modification. Referring to FIG. 22, a switch control portion 461B in the second modification includes a comparison information display portion 651, a select operation accepting portion 653, and a service-basis operation select portion 655.

Comparison information display portion 651 receives a job input from service specifying portion 453, the first subsystem information input from third subsystem information receiving portion 455, and the second subsystem information input from second subsystem information receiving portion 465. Comparison information display portion 651 generates a comparison information screen which displays the first rate defined by the first fee table and the second rate defined by the second fee table, side by side, for a process of the same process identification information. The generated comparison information screen is displayed on display unit 160A. Specifically, the comparison information screen displays the process identification information and a selection of the first fee and the second fee for that process identification information, for each of one or more processes included in the job input from service specifying portion 453.

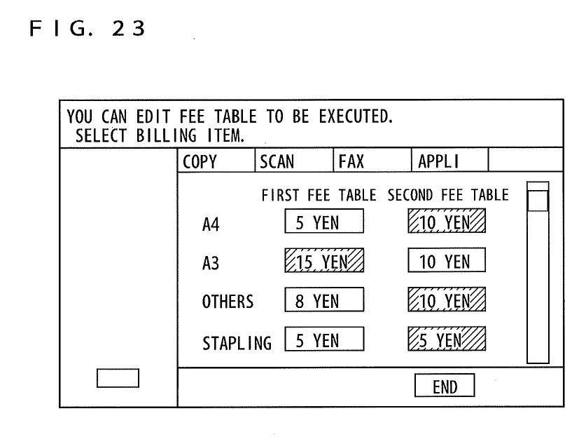

FIG. 23 is a diagram showing an example of the comparison information screen. FIG. 23 shows the comparison information screen displayed in a case where the job includes a process of printing using A4-size paper with a process name “A4,” a process of printing using A3-size paper with a process name “A3,” a process of printing using paper of any other size with a process name “other,” and a stapling process with a process name “stapling.” For each process name, the rate defined by the first fee table is displayed on the left side, and the rate defined by the second fee table is displayed on the right side.

One of the rate defined by the first fee table and the rate defined by the second fee table can be selected. In the figure, the selected state is shown by hatching.

Returning to FIG. 22, when the operation to select one of the first fee and the second fee for each process identification information included in the comparison information screen is input to operation unit 160B by the user, select operation accepting portion 653 determines the selected process identification information and which of the rate by the first fee table and the rate by the second fee table is selected. Select operation accepting portion 653 outputs a signal indicating the rate selected from the rate by the first fee table and the rate by the second charge rate to service-basis operation select portion 655, for each process identification information.

Service-basis operation select portion 655 decides which of proxy provision portion 457 and post-collection provision portion 467 will execute each of one or more processes included in the job input from service specifying portion 453, based on the signal input from select operation accepting portion 653 for each process identification information to indicate the rate by the first fee table or the rate by the second fee table. Service-basis operation select portion 655 decides on proxy provision portion 457 for the process with the process identification information in which the rate by the first fee table is selected by the user, of one or more processes included in the job input from service specifying portion 453. Service-basis operation select portion 655 decides on post-collection provision portion 467 for the process with the process identification information in which the rate by the second fee table is selected by the user, of one or more processes included in the job input from service specifying portion 453.

For each of one or more processes included in the job input from service specifying portion 453, when post-collection provision portion 467 is decided on, service-basis select portion 643 outputs a set of the process identification and the parameter of the process to post-collection provision portion 467. When proxy provision portion 457 is decided on, service-basis select portion 643 outputs a set of the process identification and the parameter of the process to proxy provision portion 457.

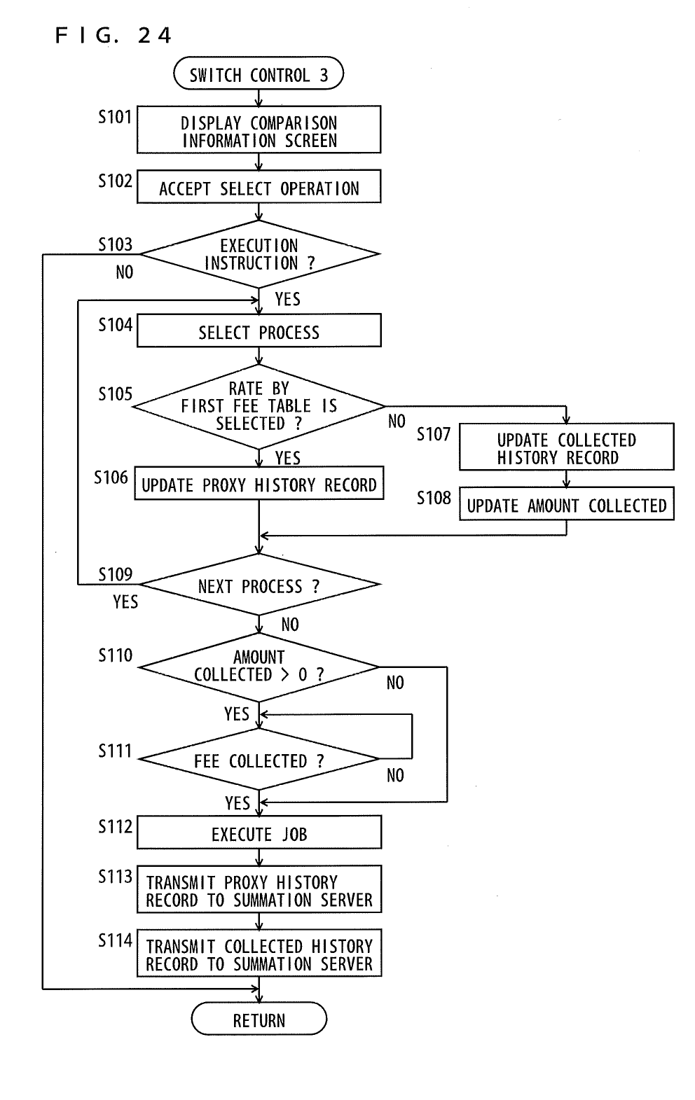

FIG. 24 is a flowchart showing an exemplary flow of a switch control process in the second modification. The switch control process in the second modification is a process executed in step S60 shown in FIG. 18. Referring to FIG. 24, CPU 111A displays the comparison information screen on display unit 160A (step S101). The comparison information screen displays, for each of one or more processes specified in step S59 in FIG. 18, the process identification information of the process and a selection of the rate defined by the first fee table and the rate defined by the second fee table for that process identification information.

In step S102, a select operation by the user is accepted. The operation to select one of the rate defined by the first fee table and the rate defined by the second fee table included in the comparison information screen is accepted for each process identification information. In step S103, it is determined whether an execution instruction is accepted. An execution instruction is accepted when it is detected that the start key of operation unit 160B is pressed by the user. If an execution instruction is accepted, the process proceeds to step S104. If not, the process returns to the second service provision process.

In step S104, one of one or more processes specified in step S59 in FIG. 18 is selected as a process target. In the next step S105, it is determined whether the rate defined by the first fee table is selected in step S102 for the process selected as a process target. If the rate defined by the first fee table is selected, the process proceeds to step S106. If not, the process proceeds to step S107.

In step S106, the proxy history record is updated, and the process then proceeds to step S109. The proxy history record includes the execution result including the process identification information of the process selected in step S104 and the number of times the process is executed, and the subsystem identification information of first subsystem 10. On the other hand, in step S107, the collected history record is updated. The collected history record includes the execution result including the process identification information of the process selected in step S104 and the number of times the process is executed. In the next step S108, the amount collected is updated, and the process then proceeds to step S109. Specifically, the second fee table stored in HDD 116 is read out, and the second billing amount for executing the process selected as a process target in step S104 is calculated. The calculated second billing amount is added to the amount collected.

In step S109, it is determined whether there exists any process not yet selected as a process target in step S104, among one or more processes specified in step S59 in FIG. 18. If a process not yet selected exists, the process returns to step S104. If none exists, the process proceeds to step S110. The process in step S110 to step S114 is the same as the process in step S89 to step S90 shown in FIG. 21. Therefore, the description will not be repeated here.

### Third Modification

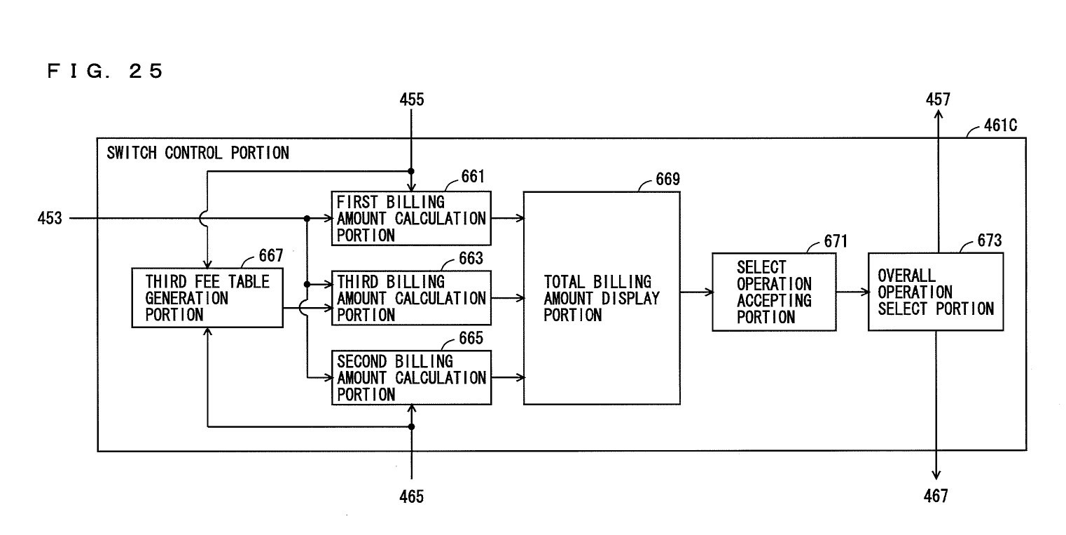

FIG. 25 is a diagram showing details of exemplary functions of a switch control portion according to a third modification. Referring to FIG. 25, a switch control portion 461C in the third modification includes a first billing amount calculation portion 661, a second billing amount calculation portion 665, a third billing amount calculation portion 663, a third fee table generation portion 667, a total billing amount display portion 669, a select operation accepting portion 671, and an overall operation select portion 673.

First billing amount calculation portion 661 receives a job input from service specifying portion 453 and the first subsystem information input from third subsystem information receiving portion 455. First billing amount calculation portion 661 refers to the first fee table included in the first subsystem information to calculate the first total billing amount for executing all of one or more processes included in the job input from service specifying portion 453. First billing amount calculation portion 631 outputs the calculated first total billing amount to total billing amount display portion 669.

Second billing amount calculation portion 665 receives a job input from service specifying portion 453 and the second subsystem information input from second subsystem information receiving portion 465. Second billing amount calculation portion 665 refers to the second fee table included in the second subsystem information to calculate the second total billing amount for executing all of one or more processes included in the job input from service specifying portion 453. Second billing amount calculation portion 665 outputs the calculated second total billing amount to total billing amount display portion 669.

Third fee table generation portion 667 receives the first subsystem information input from third subsystem information receiving portion 455 and the second subsystem information input from second subsystem information receiving portion 465. Third fee table generation portion 667 generates a third fee table by comparing the rate defined by the first fee table with the rate defined by the second fee table for the same process identification information, and employing the lower rate. If the rate defined by the first fee table is equal to the rate defined by the second fee table, the equal rate defined by them is employed. Third fee table generation portion 667 outputs the generated third fee table to third billing amount calculation portion 663.

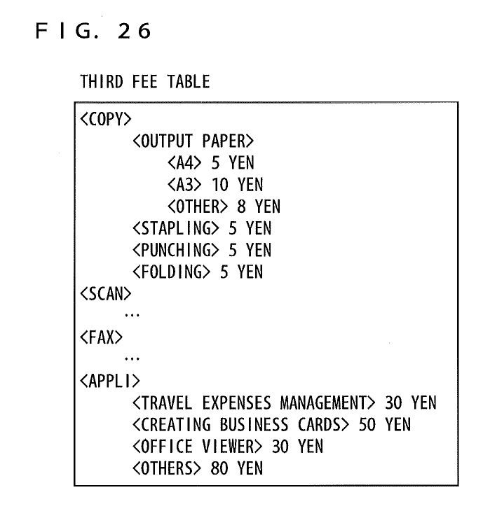

FIG. 26 is a diagram showing an example of the third fee table. Referring to FIG. 26, the third fee table defines a rate for each process. Specifically, the rate of 5 yen equal to the rate by the first fee table is set as the rate for a copy process using A4-size paper, the rate of 10 yen equal to the rate by the second fee table is set as the rate for a copy process using A3-size paper, and the rate of 8 yen equal to the rate by the first fee table is set as the rate for a copy process using paper other than A4- and A3-size paper. Furthermore, the rate of 5 yen equal to the rate by the first fee table is set as the rate for a stapling process, the rate of 5 yen equal to the rate by the first fee table is set as the rate for a punching process, and the rate of 5 yen equal to the rate by the first fee table is set as the rate for a folding process. Furthermore, the rate of 3 yen equal to the rate by the first fee table is defined as the rate for an application process for travel expenses management, the rate of 50 yen equal to the rate by the second fee table is defined as the rate for an application process for creating business cards, the rate of 30 yen equal to the rate by the second fee table is defined as the rate for an application process of Office Viewer, and the rate of 80 yen equal to the rate by the second fee table is defined as the rate for any other application process.

Third billing amount calculation portion 663 receives a job input from service specifying portion 453 and the third fee table input from third fee table generation portion 667. Third billing amount calculation portion 663 refers to the third fee table to calculate the third total billing amount for executing all of one or more processes included in the job input from service specifying portion 453. Third billing amount calculation portion 663 outputs the calculated third total billing amount to total billing amount display portion 669.

Total billing amount display portion 669 receives the first total billing amount input from first billing amount calculation portion 661, the second total billing amount input from second billing amount calculation portion 665, and the third total billing amount input from third billing amount calculation portion 663. Total billing amount display portion 669 generates a total billing amount screen and displays the generated total billing amount screen on display unit 160A.

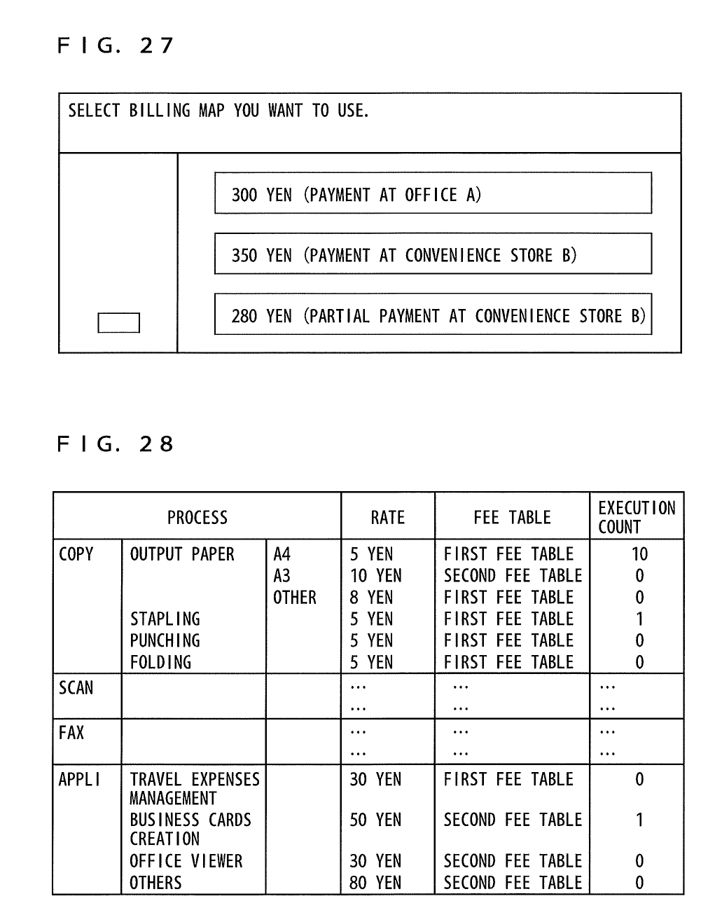

FIG. 27 is a diagram showing an example of the total billing amount screen. The total billing amount screen displays a selection of the first total billing amount, the second total billing amount, and the third total billing amount. Here, the display offers a selection of the first total billing amount “300 yen,” the second total billing amount “350 yen,” and the third total billing amount “280 yen.”

Returning to FIG. 25, when the operation to select one of the first to third total billing amounts included in the total billing amount screen is input to operation unit 160B by the user, select operation accepting portion 671 determines which of the first to third total billing amounts is selected. Select operation accepting portion 671 outputs a signal indicating one of the first to third total billing amounts to overall operation select portion 673.

When a signal indicating that the first total billing amount is selected is input from select operation accepting portion 671, overall operation select portion 673 decides on proxy provision portion 457. When a signal indicating that the second total billing amount is selected is input from select operation accepting portion 671, overall operation select portion 673 decides on post-collection provision portion 467. When post-collection provision portion 467 is decided on, overall operation select portion 673 outputs a set of process identification and parameters of all of one or more processes included in the job input from service specifying portion 453, to post-collection provision portion 467. When proxy provision portion 457 is decided on, overall operation select portion 673 outputs a set of process identification and parameters of all of one or more processes included in the job input from service specifying portion 453, to proxy provision portion 457.

When a signal indicating that the third total billing amount is selected is input from select operation accepting portion 671, overall operation select portion 673 decides which of proxy provision portion 457 and post-collection provision portion 467 will execute each of one or more processes included in the job input from service specifying portion 453, based on which of the rate by the first fee table and the rate by the second fee table is employed in the third fee table. In order to determine which rate of the first fee table and the second fee table is employed in the third fee table, overall operation select portion 673 generates an internal table and determines based on the internal table. Service-basis select portion 643 decides on proxy provision portion 457 for the process with the process identification information in which the rate by the first fee table is employed in the third fee table, of one or more processes included in the job input from service specifying portion 453. Service-basis select portion 643 decides on post-collection provision portion 467 for the process with the process identification information in which the rate by the second fee table is employed in the third fee table, of one or more processes included in the job input from service specifying portion 453. For each one or more processes included in the job input from service specifying portion 453, when post-collection provision portion 467 is decided on, overall operation select portion 673 outputs a set of the process identification information and the parameter of the process to post-collection provision portion 467. When proxy provision portion 457 is decided on, overall operation select portion 673 outputs a set of the process identification information and the parameter of the process to proxy provision portion 457.

FIG. 28 is a diagram showing an example of the internal table. The internal table shows the relation between the third fee table and the first and second fee tables, and the rate for each process, and the number of times of execution. Referring to FIG. 28, the internal table includes an item of process, an item of rate, and an item of fee table, and an item of count. The item of process specifies a process. In the item of rate, the rate employed in the third fee table is set for the process specified by the item of process. In the item of fee table, one of the first fee table and the second fee table of which rate is employed is set for the process specified by the item of process. In the item of count, the number of times the process specified by the item of process is executed is set.

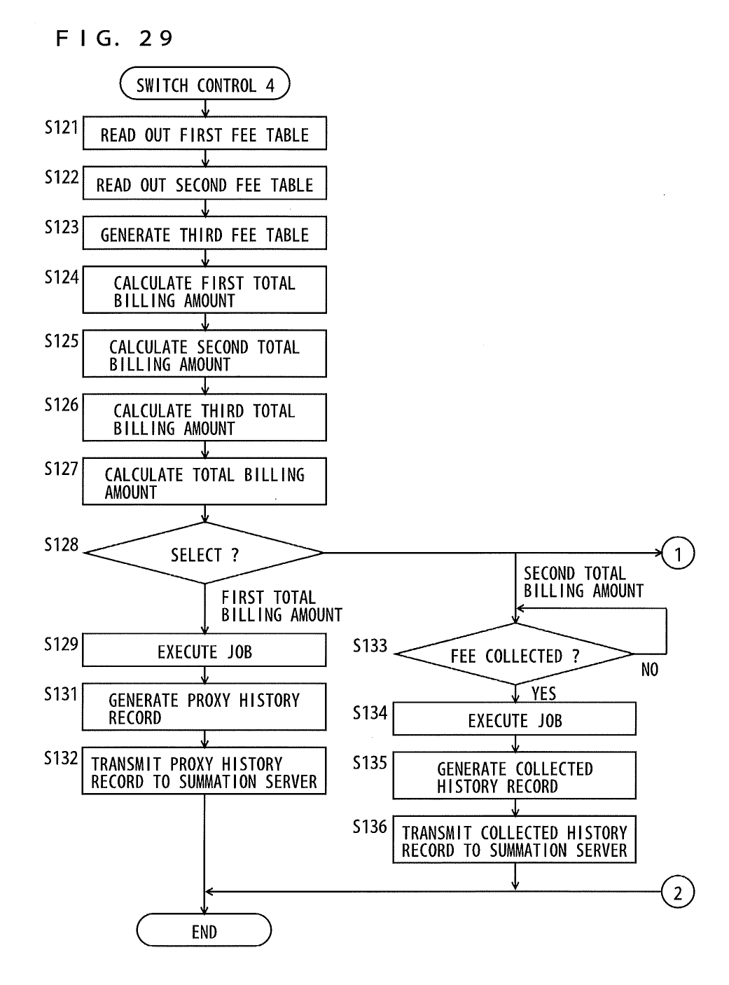

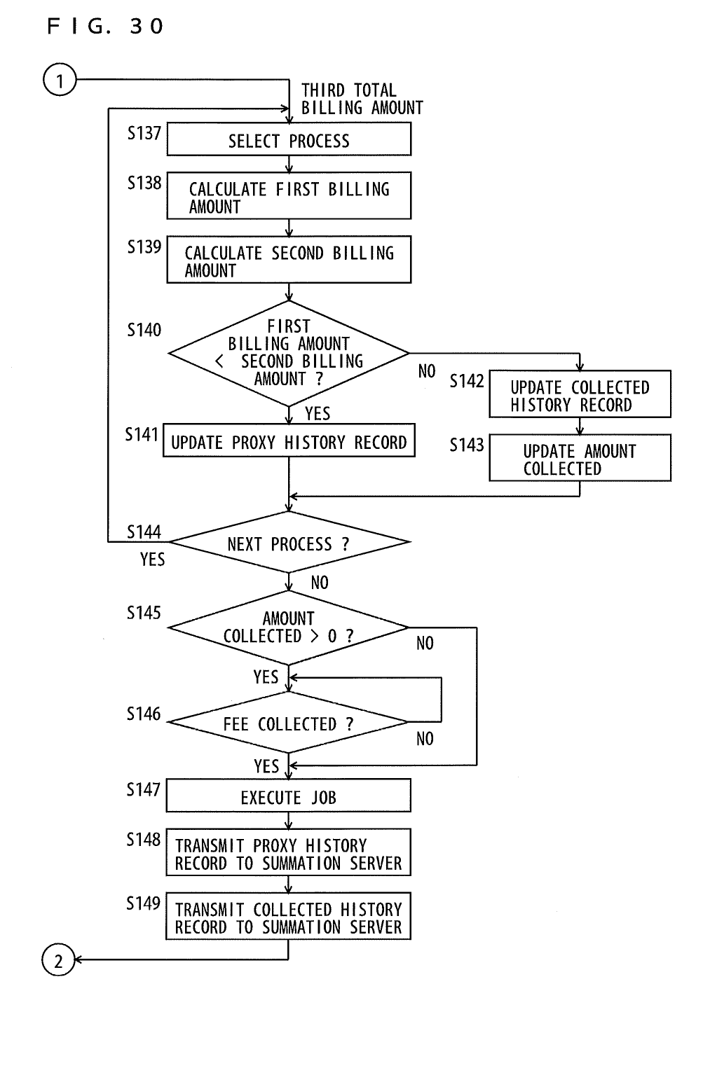

FIG. 29 and FIG. 30 are flowcharts showing an exemplary flow of a switch control process in the third modification. The switch control process in the third modification is a process executed in step S60 shown in FIG. 18. Referring to FIG. 29, CPU 111A reads out the first fee table from HDD 116 (step S121). In the next step S122, the second fee table is read out from HDD 116. In the next step S123, the third fee table is generated from the first fee table and the second fee table. The third fee table is generated by comparing the rate defined by the first fee table with the rate defined by the second fee table for the same process identification information, and employing the lower rate.

In step S124, the first total billing amount is calculated. Specifically, the first total billing amount for executing all of one or more processes specified in step S59 in FIG. 18 is calculated, referring to the first fee table read out from HDD 116 in step S121.

In the next step S125, the second total billing amount is calculated. Specifically, the second total billing amount for executing all of one or more processes specified in step S59 in FIG. 18 is calculated, referring to the second fee table read out from HDD 116 in step S122.

In the next step S126, the third total billing amount is calculated. Specifically, the third total billing amount for executing all of one or more processes specified in step S59 in FIG. 18 is calculated, referring to the third fee table generated in step S123.

In the next step S127, the total billing amount screen is displayed on display unit 160A. Specifically, the generated total billing amount screen offers a selection of the first total billing amount, the second total billing amount, and the third total billing amount. The generated total billing amount screen is displayed on display unit 160A.

Then, it is determined which of the first total billing amount, the second total billing amount, and the third total billing amount is selected (step S128). The operation by the user on operation unit 160B to select one of the first total billing amount, the second total billing amount, and the third total billing amount is accepted. If the first total billing amount is selected, the process proceeds to step S129. If the second total billing amount is selected, the process proceeds to step S133. If the third total billing amount is selected, the process proceeds to step S137.

The process in step S129 to step S132 is the same as the process in step S74 to step S76 shown in FIG. 19. The process in step S133 to step S136 is the same as the process in step S77 to step S80 in FIG. 19. The process in step S137 to step S149 is the same as the process in step S81 to step S93 in FIG. 21. Therefore, the description will not be repeated here.

As described above, service provision system 1 in the present embodiment includes first subsystem 10 and second subsystems 20, 20A and 20B. One of MFPs 100 and 100A to 100C included in first subsystem 10 downloads the first subsystem information including the first fee table defined for first subsystem 10 and the subsystem identification information of first subsystem 10 from summation server 500. If the registered user is authenticated, the first subsystem information is transmitted to portable information device 600 carried by the user. When the user receives provision of a service at any one of second subsystems 20, 20A, and 20B, for example, when the user receives provision of a service from second subsystem 20, the first subsystem information is transmitted from portable information device 600 to MFP 400 in second subsystem 20. Then, MFP 400 compares the first fee table with the second fee table defined for second subsystem 20 and selects one of the first fee table and the second fee table to provide a service. Specifically, MFP 400 selects to provide a service on the condition that the fee defined by the second fee table is collected, or selects to provide a service before the fee for the service is collected and to transmit a proxy history record including the history record and the first subsystem identification information to the summation server. Therefore, the user can receive provision of a service for the fee defined by the first fee table when receiving provision of a service at any one of second subsystem 20, 20A, and 20B.

The first total billing amount obtained by calculating the total fee for the process specified by the user using the first fee table is compared with the second total billing amount obtained by calculating the same using the second fee table. If the first total billing amount is smaller than the second total billing amount, the first fee table is used for billing. If the second total billing amount is equal to or smaller than the first total billing amount, the second fee table is used for billing. Therefore, a service can be provided with one of a plurality of fee systems.

According to the first modification, the rate defined by the first fee table is compared with the rate defined by the second fee table for the same process. For the process whose rate defined by the first fee table is lower than the rate defined by the second fee table, the first fee table is used for billing. For the process whose rate defined by the second fee table is equal to or smaller than the rate defined by the first fee table, the second fee table is used for billing. Therefore, a service can be provided at the lowest fee because one of a plurality of fee systems is selected for each service.

According to the second modification, for the process specified by the user, the rate defined by the first fee table and the rate defined by the second fee table are displayed to allow a selection therebetween. For the process for which the user selects the first fee table, the first fee table is used for billing. For the process for which the user selects the second fee table, the second fee table is used for billing. Therefore, a service can be provided with a fee system selected by the user from a plurality of fee systems for each of a plurality of processes.

According to the third modification, the third fee table is generated by comparing the rate defined by the first fee table with the rate defined by the second fee table for the same process, and employing the lower fee. The first total billing amount obtained by calculating the total fee for the process specified by the user using the first fee table, the second total billing amount obtained by calculating using the second fee table, and the third total billing amount obtained by calculating using the third fee table are displayed. When the first total billing amount is selected by the user, the first fee table is used for billing. When the second total billing amount is selected, the second fee table is used for billing. When the third total billing amount is selected, the first fee table is used for billing for the process whose rate defined by the first fee table is lower than the rate defined by the second fee table, whereas the second fee table is used for billing for the process whose rate defined by the second fee table is equal to or smaller than the rate defined by the first fee table. Therefore, a service can be provided with one of a plurality of fee systems.

MFPs 100, 100A to 100C, 400, 400A, and 400B, each capable of executing an image forming process of forming an image of data, a data storage process of storing data, a data transmission/reception process of transmitting/receiving data, an image processing process of processing image data, and a post processing process, can provide a service of forming an image of data, a service of storing data, and a service of transmitting data.

The user can allow any one of MFPs 100, 100A to 100C, 400, 400A, and 400B to execute a process.

In the foregoing embodiment, service provision system 1 has been described. However, the present invention can be understood as a service provision method allowing summation server 500 to execute the process shown in FIG. 13 and FIG. 14, allowing local server 200 of first subsystem 10 to execute the process shown in FIG. 15 and FIG. 16, allowing each of MFPs 100 and 100A to 100C to execute the process shown in FIG. 17, and allowing each of MFPs 400, 400A and 400B of second subsystems 20, 20A and 20B to execute the process shown in FIG. 18 and FIG. 19. The present invention can also be understood as a service provision program causing a computer for controlling each of summation server 500, local server 200, and MFP 100, 100A to 100C, 400, 400A, and 400B to execute the service provision method. The process shown in FIG. 19 can be replaced by the process in FIG. 21, the process in FIG. 24, or the process in FIG. 29 and FIG. 30.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A service provision system including a summation server and a plurality of subsystems,
said summation server comprising:
a subsystem-basis fee table storing portion to store, for each of said plurality of subsystems, a fee table that defines a fee for a service provided by the subsystem;
a history record acquisition portion to acquire a history record of providing a service from each of said plurality of subsystems; and
a summation portion to sum a billing amount using a fee table for each of said plurality of subsystems, based on the acquired history record,
said plurality of subsystems including a first kind and a second kind,
the subsystem of said first kind comprising:
a first fee table receiving portion to receive a first fee table for the subsystem from said summation server;
a first authentication portion to authenticate a user registered in advance in the subsystem of said first kind;
a user-restricted provision portion to provide a service on condition that a user is authenticated as the registered user;
an uncollected history record transmitting portion to transmit to said summation server an uncollected history record including a history record of said user-restricted provision portion providing a service; and
a subsystem information transmitting portion to, in response to a request from a portable information device carried by the registered user, transmit to said portable information device first subsystem information including said first fee table and subsystem identification information for identifying the subsystem of said first kind,
the subsystem of said second kind comprising:
a second fee table receiving portion to receive a second fee table for the subsystem from said summation server;
a post-collection provision portion to provide a service on condition that a fee defined by said received second fee table is collected;
a collected history record transmitting portion to transmit to said summation server a collected history record including a history record of said post-collection provision portion providing a service;
a subsystem information receiving portion to receive said first subsystem information including said first fee table and said subsystem identification information from said portable information device carried by the user;
a proxy provision portion to provide a service before a fee for the service is collected, if said first subsystem information is received by said subsystem information receiving portion;
a proxy history record transmitting portion to transmit to said summation server a proxy history record including a history record of said proxy provision portion providing a service and said subsystem identification information included in said first subsystem information;
an operation accepting portion to accept a user's operation;
a service specifying portion to obtain service specifying information accepted by said operation accepting portion for specifying a service; and
a switch control portion to compare said first fee table with said second fee table for providing the service specified by said obtained service specifying information, and to allow one of said post-collection provision portion and said proxy provision portion to provide a service.

2. The service provision system according to claim 1, wherein
said switch control portion includes
a first billing amount calculation portion to calculate a total fee for the service specified by said obtained service specifying information, as a first total billing amount, using said first fee table,
a second billing amount calculation portion to calculate a fee for the service specified by said obtained service specifying information, as a second total billing amount, using said second fee table, and
a total select portion to allow said proxy provision portion to provide the service if said first total billing amount is smaller than said second total billing amount, and to allow said post-collection provision portion to provide the service if said second total billing amount is equal to or smaller than said first total billing amount.

3. The service provision system according to claim 1, wherein said switch control portion includes
a comparison portion to compare a fee defined by said first fee table with a fee defined by said second fee table for a same service, and
a service-basis select portion, wherein for a service in which a fee defined by said first fee table is lower than a fee defined by said second fee table, of the service specified by said obtained service specifying portion, said service-basis select portion allows said proxy provision portion to provide the service, and for a service in which said second fee table defines a fee equal to or lower than that of said first fee table, of the service specified by said obtained service specifying information, said service-basis select portion allows said post-collection provision portion to provide the service.

4. The service provision system according to claim 1, wherein said switch control portion includes
a comparison information display portion to display a first fee defined by said first fee table and a second fee defined by said second fee table for the service specified by said obtained service specifying information,
a select operation accepting portion to accept an operation by a user to select one of said first fee and said second fee for the service specified by said obtained service specifying information, and
a service-basis operation select portion, wherein for a service for which said first fee is selected by said accepted operation, of the service specified by said obtained service specifying information, said service-basis operation select portion allows said proxy provision portion to provide the service, and for a service for which said second fee is selected by said accepted operation, of the service specified by said obtained service specifying information, said service-basis operation select portion allows said post-collection provision portion to provide the service.

5. The service provision system according to claim 1, wherein
said switch control portion includes
a third fee table generation portion to generate a third fee table by comparing a fee defined by said first fee table with a fee defined by said second fee table for a same service and by employing the lower fee,
a first billing amount calculation portion to calculate a total billing amount for the service specified by said obtained service specifying information, as a first total billing amount, using said first fee table,
a second billing amount calculation portion to calculate a total billing amount for the service specified by said obtained service specifying information, as a second total billing amount, using said second fee table,
a third billing amount calculation portion to calculate a total billing amount for the service specified by said obtained service specifying information, as a third total billing amount, using said third fee table,
a total billing amount display portion to display said first to third total billing amounts,
a select operation accepting portion to accept an operation by a user to select one of said first to third total billing amounts for the service specified by said obtained service specifying information, and
an overall operation select portion wherein: if said first total billing amount is selected by said accepted operation, said overall operation select portion allows said post-collection provision portion to provide the service; if said second total billing amount is selected by said accepted operation, said overall operation select portion allows said proxy provision portion to provide the service; and if said third total billing amount is selected by said accepted operation, for a service in which said first fee table defines a billing amount lower than said second fee table, of the service specified by said obtained service specifying information, said overall operation select portion allows said proxy provision portion to provide the service, and for a service in which said second fee table defines a billing amount equal to or lower than said first fee table, of the service specified by said obtained service specifying information, said overall operation select portion allows said post-collection provision portion to provide the service.

6. The service provision system according to claim 1, wherein each of said user-restricted provision portion of the subsystem of said first kind, and said proxy provision portion and said post-collection provision portion of the subsystem of said second kind includes a process execution portion capable of executing one or more processes.

7. The service provision system according to claim 6, said process execution portion includes
an image forming portion to form an image of data,
a data storage portion to store data,
a data transmission/reception portion to transmit/receive data, and
an image processing portion to process image data.

8. The service provision system according to claim 1, wherein the subsystem of said second kind further includes a fee collecting portion to collect a fee.

9. The service provision system according to claim 1, wherein the subsystem of said first kind includes a plurality of image forming apparatuses each having said user-restricted provision portion, and a local server to manage said plurality of image forming apparatuses.

10. A service provision method executed in a service provision system including a summation server and a plurality of subsystems,
said summation server including a subsystem-basis fee table storing portion to store, for each of said plurality of subsystems, a fee table that defines a fee for a service provided by the subsystem,
said method allowing said summation server to execute:
a step of acquiring a history record of providing a service from each of said plurality of subsystems; and
a step of summing a billing amount using the fee table for each of said plurality of subsystems, based on said acquired history record,
said plurality of subsystems including a first kind and a second kind,
said method allowing the subsystem of said first kind to execute:
a step of receiving a first fee table for the subsystem from said summation server;
a step of authenticating a user registered in advance in the subsystem of said first kind;
a user-restricted provision step of providing a service on condition that a user is authenticated as the registered user;
a step of transmitting to said summation server an uncollected history record including a history record of providing a service in said user-restricted provision step; and
a step of, in response to a request from a portable information device carried by the registered user, transmitting to said portable information device first subsystem information including said first fee table and subsystem identification information for identifying the subsystem of said first kind,
said method allowing the subsystem of said second kind to execute:
a step of receiving a second fee table for the subsystem from said summation server;
a post-collection provision step of providing a service on condition that a fee defined by said received second fee table is collected;
a step of transmitting to said summation server a collected history record including a history record of providing a service in said post-collection provision step;
a step of receiving said first subsystem information including said first fee table and said subsystem identification information from said portable information device carried by the user;
a proxy provision step of providing a service before a fee for the service is collected, if said first subsystem information is received;
a proxy history record transmitting step of transmitting to said summation server a proxy history record including a history record of providing a service in said proxy provision step and said subsystem identification information included in said first subsystem information;
a step of accepting a user's operation;
a step of obtaining service specifying information accepted in said step of accepting a user's operation for specifying a service; and
a switch control step of comparing said first fee table with said second fee table for providing the service specified by said obtained service specifying information, and executing one of said post-collection provision step and said proxy provision step.

11. The service provision method according to claim 10, wherein
said switch control step includes
a first billing amount calculation step of calculating a total fee for the service specified by said obtained service specifying information, as a first total billing amount, using said first fee table,
a second billing amount calculation step of calculating a fee for the service specified by said obtained service specifying information, as a second total billing amount, using said second fee table, and
a total select step of allowing said proxy provision step to provide the service if said first total billing amount is smaller than said second total billing amount, and allowing said post-collection provision step to provide the service if said second total billing amount is equal to or smaller than said first total billing amount.

12. The service provision method according to claim 10, wherein said switch control step includes
a comparison step of comparing a fee defined by said first fee table with a fee defined by said second fee table for a same service, and
a service-basis select step of, for a service in which a fee defined by said first fee table is lower than a fee defined by said second fee table, of the service specified by said obtained service specifying portion, allowing said proxy provision step to provide the service, and for a service in which said second fee table defines a fee equal to or lower than that of said first fee table, of the service specified by said obtained service specifying information, allowing said post-collection provision step to provide the service.

13. The service provision method according to claim 10, wherein said switch control step includes
a comparison information display step of displaying a first fee defined by said first fee table and a second fee defined by said second fee table for the service specified by said obtained service specifying information,
a select operation accepting step of accepting an operation by a user to select one of said first fee and said second fee for the service specified by said obtained service specifying information, and
a service-basis operation select step of, for a service for which said first fee is selected by said accepted operation, of the service specified by said obtained service specifying information, allowing said proxy provision step to provide the service, and for a service for which said second fee is selected by said accepted operation, of the service specified by said obtained service specifying information, allowing said post-collection provision step to provide the service.

14. The service provision method according to claim 10, wherein
said switch control step includes
a third fee table generation step of generating a third fee table by comparing a fee defined by said first fee table with a fee defined by said second fee table for a same service and by employing the lower fee,
a first billing amount calculation step of calculating a total billing amount for the service specified by said obtained service specifying information, as a first total billing amount, using said first fee table,
a second billing amount calculation step of calculating a total billing amount for the service specified by said obtained service specifying information, as a second total billing amount, using said second fee table,
a third billing amount calculation step of calculating a total billing amount for the service specified by said obtained service specifying information, as a third total billing amount, using said third fee table,
a total billing amount display step of displaying said first to third total billing amounts,
a select operation accepting step of accepting an operation by a user to select one of said first to third total billing amounts for the service specified by said obtained service specifying information, and
an overall operation select step of if said first total billing amount is selected by said accepted operation, allowing said post-collection provision step to provide the service; if said second total billing amount is selected by said accepted operation, allowing said proxy provision step to provide the service; and if said third total billing amount is selected by said accepted operation, for a service in which said first fee table defines a billing amount lower than said second fee table, of the service specified by said obtained service specifying information, allowing said proxy provision step to provide the service, and for a service in which said second fee table defines a billing amount equal to or lower than said first fee table, of the service specified by said obtained service specifying information, allowing said post-collection provision step to provide the service.

15. The service provision method according to claim 10, wherein each of said user-restricted provision step of the subsystem of said first kind, and said proxy provision step and said post-collection provision step of the subsystem of said second kind includes a process execution step of capable of executing one or more processes.

16. The service provision method according to claim 15, said process execution step includes
an image forming step of forming an image of data,
a data storage step of storing data,
a data transmission/reception step of transmitting/receiving data, and
an image processing step of processing image data.

17. The service provision method according to claim 10, wherein the subsystem of said second kind further includes a fee collecting step for collecting a fee.

18. The service provision method according to claim 10, wherein the subsystem of said first kind includes a plurality of image forming apparatuses each having said user-restricted provision step, and a local server to manage said plurality of image forming apparatuses.
